(19) United States
(12) Patent Application Publication
(10) Pub. No.: US 2005/0075926 A1
(43) Pub. Date: Apr. 7, 2005

(54) On-line promotion server

(75) Inventors: Wanqian D. Liu, Fremont, CA (US); Song Li, Campbell, CA (US); Robert J. Zhang, Palo Alto, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignees: Informlink, Inc., Sunnyvale, CA (US); Computer Science Corporation, El Segundo, CA (US)

(21) Appl. No.: 10/456,855

(22) Filed: Apr. 10, 2002

Related U.S. Application Data
(63) Continuation of application No. 09/915,690, filed on Jul. 25, 2001, now abandoned.
(60) Provisional application No. 60/220,551, filed on Jul. 25, 2000.

(51) Int. Cl. G06F 17/60

(52) U.S. Cl. 705/14

(57) ABSTRACT

A central server for providing a promotion to a plurality of application servers includes a processor, and a tangible media coupled to the processor, the tangible media including code that directs the processor to receive from a user at a client system promotion setup data for the promotion, code that directs the processor to receive a specification of an offer data for the promotion from the user, code that directs the processor to receive a promotion targeting specification for the promotion from the user, code that directs the processor to receive a specification of a method for delivering the promotion to the plurality of application servers, code that directs the processor to form a specification for the promotion in response to the promotion identifier, the offer type, the promotion targeting specification, and the method for delivering the promotion, code that directs the processor to store the specification in a memory, and code that directs the processor to transmit the promotion to the plurality of application servers.

### CROSS-REFERENCES TO RELATED APPLICATIONS

This application claims priority to Provisional Application No. 60/220548 filed Jul. 25, 2000, provisional Application No. 60/220551 filed Jul. 25, 2000, application Ser. No. 09/834855 filed Apr. 12, 2001, application Ser. No. 09/834851 filed Apr. 12, 2001, and Provisional Application No. ______, filed Jul. 18, 2001, Attorney Docket No 020683-000500US, titled Universal Promoter System and Method. These applications are hereby incorporated by reference for all purposes.

### BACKGROUND OF THE INVENTION

The present invention relates to methods and systems for creating and distributing promotions across a computer network. Further, the present invention relates to methods and systems for specifying promotions and distributing promotions across a computer network.

Under economic theory, the law of supply and demand suggests that an equilibrium between the number of goods produced and a product price can be reached in the free market. However, not content with profits at such equilibriums, marketers and promoters have tried to find ways to attract buyers who would not have purchased the product at the equilibrium price. Such buyers may be termed “target buyers.” One conventional way to attract target buyers has been through the use of traditional paper-based coupons.

As is well known, coupons are detachable, possessable certificates that possess a monetary value. For example, typical coupons may be worth 1/10¢, 1/20¢, or the like. The real “worth” of traditional coupons are that they provide the bearer or presenter with proof of the right to exercise a predetermined bargain. For example, it allows the bearer to “save $1,” off the price of a CD; it allows the bearer to “get one free” with purchase of “one;” and the like. Traditionally, marketers/promoters of products provide consumers with coupons to attract purchasers who otherwise would not have considered purchasing the product, i.e. target buyers.

A problem with traditional coupons includes that coupons often end up in the hands of buyers who are not targeted. This is because distributing coupons only to target buyers is virtually impossible. Although some coupons may be distributed to channels such as magazines, direct mailings, and the like that include a large percentage of target buyers, a significant percentage nevertheless reaches non-target buyers. These non-target buyers may include those willing to purchase the product even without the coupon. Accordingly, if non-target buyers uses the coupons to purchase a product, this directly reduces the amount of profit to the promoter. As an example, a promoter may create a promotion directed to Pepsi™ drinkers to try Coke™. To do so, the promoter offers coupons providing the bearer with a dollar off a six-pack of Coke™. However, it is virtually impossible to prevent a devoted Coke™ drinker from picking and redeem that coupon. This sort of common situation directly “siphons-off” manufacturer profits.

Thus, in light of the above, what is needed in the industry are improved methods and apparatus for specifying promotions to users while reducing the drawbacks discussed above.

### SUMMARY OF THE INVENTION

The present invention relates to methods and systems for creating promotions and distributing promotions across a computer network. Further, the present invention relates to methods and systems for specifying and monitoring promotions across a computer network.

In one embodiment, as on-line consumers browse through the aisles of an online store and decide what to put in their shopping cart, the system described below allows marketers to communicate with the consumers and impact their buying decisions. In particular, embodiments of the present invention provide help marketers offer various real-time promotions based on special targeting criteria. Accordingly, marketers can convey a variety of messages to a variety of target consumers at critical moments when the consumer is making choices. Such promotions benefit consumers, who receive valuable personalized content, and benefit online retailers or the like, who experience increased sales and site-loyalty.

Embodiments of the present invention deliver real-time promotions. The assignee of the present invention provides Electronic Consumer Incentives™ (ECI™) brand real-time promotions to on-line customers as they shop. The real-time promotions are dynamically displayed on consumers' computer screens in an unobtrusive manner as consumers navigate though online stores making purchase decisions. Different real-time promotions are viewed by each consumer, depending on how consumers fit promotion targeting criteria specified by the promoter (marketers). In some embodiments, as a consumer places an item in her shopping cart or navigates to a different “aisle” or category in an on-line store, different real-time promotions will appear on her computer screen. One embodiment of this real-time promotion is implemented using products and services available from the current assignee including: InformLink's Web Portal and InformLink.Net.

According to one aspect of the invention, a central server for providing a promotion to a plurality of application servers is disclosed. One such server includes a processor and a tangible media coupled to the processor. The tangible media may include code that directs the processor to receive from a user at a client system promotion setup data for the promotion, code that directs the processor to receive a specification of an offer data for the promotion from the user, and code that directs the processor to receive a promotion targeting specification for the promotion from the user. The tangible media may also include code that directs the processor to receive a specification of a method for delivering the promotion to the plurality of application servers, code that directs the processor to form a specification for the promotion in response to the promotion identifier, the offer type, the promotion targeting specification, and the method for delivering the promotion, and code that directs the processor to store the specification in a memory. Code that directs the processor to transmit the promotion to the plurality of application servers may also be included.

According to another aspect of the invention, a client system for defining a promotion for distribution to a plurality of servers is disclosed. The client system may include a display, means for receiving a plurality of web pages to be displayed on the display, the plurality of web pages specified by a central server, and means for displaying a plurality of web pages on the display. The client system may also include means for receiving setup data for the promotion from the user in response to a first prompt on the plurality of web pages on the display, means for receiving a specification of an offer for the promotion from the user in response to a second prompt on the plurality of web pages on the display, and means for transmitting the setup data and the specification of the offer to the central server using TCP/IP. The central server transmits a specification for the promotion to the plurality of servers, the specification including the setup data and the specification of the offer.

According to yet another aspect of the invention, a computer program product for a central server including a processor for distributing promotions to a plurality of servers is described. The computer program product may include code that directs the processor to provide a plurality of web pages for display to a client system, code that directs the processor to receive promotion setup data from the client system, the promotion setup data provided by a promoter in response to a first prompt on the plurality of web pages, and code that directs the processor to receive an offer specification from the client system, the offer specification provided by the promoter in response to a second prompt on the plurality of web pages. Additionally, the computer program product may include code that directs the processor to receive a targeting specification for the promotion from the client system, the targeting specification provided by the promoter in response to a third prompt on the plurality of web pages, code that directs the processor to form a promotion specification in response to the promotion setup data, the offer specification, and the targeting specification, code that directs the processor to store the promotion specification in a database, and code that directs the processor to distribute at least a portion of the promotion specification to only the plurality of servers from a superset of servers in response to the promotion specification. The codes may reside on a tangible media such as a CD-ROM, Hard Disk, floppy disk, removable and non-removable media, or the like.

### BRIEF DESCRIPTION OF THE DRAWINGS

In order to more fully understand the present invention, reference is made to the accompanying drawings. Understanding that these drawings are not to be considered limitations in the scope of the invention, the presently preferred embodiments and the presently understood best mode of the invention are described with additional detail through use of the accompanying drawings in which:

FIG. 1 illustrates a block diagram according to an embodiment of the present invention;

FIG. 2 is a block diagram of typical computer system 200 according to embodiments of the present invention;

FIGS. 3A-B illustrate a block diagram of a flow chart according to an embodiment of the present invention;

FIG. 4 illustrates a logical state diagram according to an embodiment of the present invention;

FIG. 5 illustrates a block diagram according to an embodiment of the present invention;

FIGS. 6A-Q illustrate graphical user interfaces according to embodiments of the present invention; and

FIGS. 7A-B illustrate graphical user interfaces of reports according to embodiments of the present invention.

### DESCRIPTION OF THE SPECIFIC EMBODIMENTS

The following terms are used in the present application:

Brand—A specific group of related products.

Category—Hierarchical product association, (e.g. Disposal Diapers).

Category ID/Listing—A number assigned to a category.

Category Structure—also called Product Categorization or (sometimes it is also used as Product Classification). A fat-tree structure (acyclic DAG) that defines a parent-child category relationship as well as a set of product identifiers and sub categories. Each node of the tree is a category (node). If a category has child categories, it is also called a supercategory or parent category of the child category. If a category has parent category it is also called subcategory of its parent category. A category can have multiple parent categories. A category without child is called a leaf category, which corresponds to a leaf node in a tree structure. Typically, a product identifier is associated to the leaf category. But non-leaf category can also be associated to product identifiers along with other subcategories. It should be understood that the term “tree,” “tree structure” or the like, used herein refers to many possible types of trees that can be used in the embodiments of the present invention, such as a fat-tree structure, and the like.

Cents Off—Cents off promotions are used for giving a specific dollar amount of a product or groups of products. Example: Buy any widget get $.50 off or buy any widget and any trinket save $1.00. More generally, such promotions describe an amount of monetary savings available.

Creation Date—The date the promotion was created.

Cycle—A defined period of time that a promotion can run. In one embodiment, there are 13 cycles a year and manufacturers/promoters have the ability to run promotions in a certain category per cycle.

Description—Description for the promotion. Example: Any 12-oz. Soft Drink.

Display Types—A display type is selected when the promoter determines how a promotion should be displayed on a customer display. Display types include static and trigger. A static display is delivered in a specific aisle of the store. A triggered display is delivered from a current shopping pattern of a customer or based upon items within a current customer cart.

Division—Hierarchical reporting level inside a Company that is used for grouping brands together.

Effective Date—The date the promotion begins.

Electronic Consumer Incentives™ (ECI™)—Informlink's brand real-time promotions delivered to customers as they shop.

Expiration Date—The date the promotion ends.

Free Value—Free Value is used for running a ‘Buy X, Get Y Free” promotion, or for giving away a free sample. Example: Buy one widget get one free, buy widget A get widget B free.

Name—The Brand Manager's, Promoter's, Manufacturer's name.

Offer Description—A description of the promotion/offer.

Offer Setup—Detailed rules the promoter enters to define the offer.

Offer Tracking Code—A unique number assigned by the Brand Manager or Retailer. This code becomes the permanent identifying number that is used for all future queries, tracking and reporting. In one embodiment the field can be 10 characters.

Offer Type—An offer type is the type of offer the product wants to execute.

Participating Retailers—Retailers or Merchants that will display the promotion.

Price Point—Price Points are used to promote an item or items at a certain price. Example: Buy any widget for $2.99.

Product UPC—A universal product code that uniquely identifies and defines each product.

Program Manager—A Program Number is used to group a set of promotions together. An example would be a campaign using multiple promotions for a common theme. The program number allows the promoter to receive reports of all promotion activity for a campaign under a master number.

Promotional Content—Used for displaying recipes or product information. This can be used alone or in conjunction with another offer type. Embodiments require a link to a URL that will contain the text copy, however content may also be maintained locally.

Restriction—Limitations of the promotion. Example: Limit one per customer.

Title—Title or name of the promotion. Example: Save $2.00.

Promotional Content URL—Retailer's website address.

UPID—UPID (Universal Promoter Identification) is selected from a list or entered manually—An invoice number that is used by the central data server to track promotions created by marketers (promoters).

User ID—An ID that identifies the user (e.g. brand manager/promoter, retailer/merchant).

User Name—Name of the assigned user, brand manager or retailer.

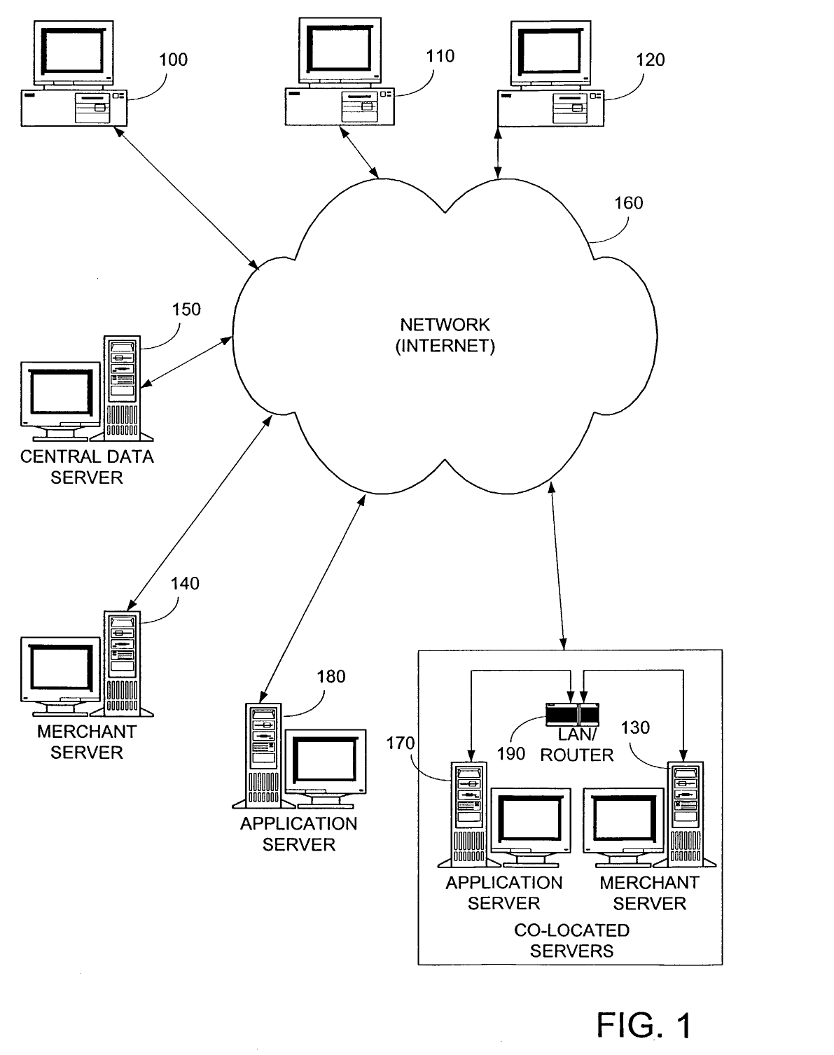

FIG. 1 illustrates a block diagram according to an embodiment of the present invention. FIG. 1 illustrates a promoter system 100, client systems 110 and 120, merchant servers 130 and 140, and a central data server 150 coupled to a computer network 160. Merchant server 130 is coupled to an application server 170, and Merchant server 140 is coupled to an application server 180.

In the present embodiment, promoter system 100 and client systems 110-120 are standard personal computers used by business, individuals, and the like. Client systems 110-120 are used by users to communicate with merchant servers 130 and/or 140. In the present example, promoter system 100 and client systems 110-120 typically use web browser programs, and other software, as will be described further below.

Promoter system 100 and client systems 110-120 are typically connected to computer network 160 via dial-up, ISDN, DSL, cable, satellite modems or the like, via wireless network interface hardware, or the like. Merchant servers 130 and 140, and data server 150 are typically connected to computer network 160 through high bandwidth channels, such as T1 or T3. Further, local area networks and routers (LANs) may also be used by client systems 100-120, merchant servers 130 and 140 and/or data server 150.

In this example, merchant servers 130 and 140 are typically web servers and/or gateway servers. Such servers may or may not be physically resident on the merchants property. As web servers, merchant servers 130 and 140 are typically used to host the merchant's web site including storage of web pages, a database, and the like.

Coupled to merchant servers 130 and 140 are application servers 170 and 180, respectively. In one embodiment, application server 170 is coupled to merchant server 130 via a LAN 190, or the like. In such an embodiment, application server 170 and merchant server 130 may be co-located at the same server facility. Advantages to co-location include that communication between merchant server 130 and application server 170 is enhanced and server response latencies are greatly reduced.

In another embodiment, application server 180 is coupled to merchant server 140 via computer network 160. In this embodiment, communication between these servers may be via a virtual private network (VPN), or other secure protocol, such as an SSL or S-HTTP. In still other embodiments, application server 180 may provide services to more than one merchant server. For example, application server 180 may provide services to merchant server 140, to merchant server 130 as a back-up for application server 170, and for other merchant servers that do not have a co-located application server.

Promoter system 100 is typically coupled to data server 150 via computer network 160. In other embodiments, other types of communications channels may be used, such as direct dial-up, or the like. In this embodiment, promoter system 100 is used by a user to specify parameters of a real-time promotion (or electronic incentive) to be stored and implemented in data server 150, as will be described further below. In the present embodiment, data server 150 may include a web server application that communicates with promoter system 100.

In the present embodiment, data server 150 provides promotion data to application servers 170 and 180 via computer network 160. Additionally, data server 150 receives return data from application servers 170 and 180 via computer network 160. More specifically, as will be discussed below, data server 150 “packages” the real-time promotion parameters received from promoter system 100 and provides promotion data to application servers 170 and 180. In return, application servers 170 and 180 provide promotion usage data back to data server 150. In other embodiments, other forms of communications channels may be used between the servers 150, 170, and 180, such as direct dial-up connections, rf, satellite, and other wireless communications schemes, and the like.

Computer network 160 is typically a wide area network (WAN) such as the Internet, or the like. In this embodiment, computer network 160 may use communication protocols such as TCP/IP, RTP, RTSP, or the like for the transfer of data. In other embodiments, computer network 160 may be a local area network (LAN), based upon TCP/IP, IPX, or the like. As mentioned above, computer network 160 provides data communication among systems 100-120, servers 130-140, 170, and 180, and other computer servers and systems. Data communication may include transfer of HTML based data, textual data, form submissions, plug-in programs or viewers, applets, packetized audio or video data, real-time streaming data, and the like. Although computer network 160 is illustrated as a single entity, as is the case with the Internet, it should be understood that computer network 160 may actually be a network of individual computers and servers.

The diagram in FIG. 1 is merely an illustration which should not limit the scope of the claims herein. One of ordinary skill in the art would recognize many other variations, modifications, and alternatives.

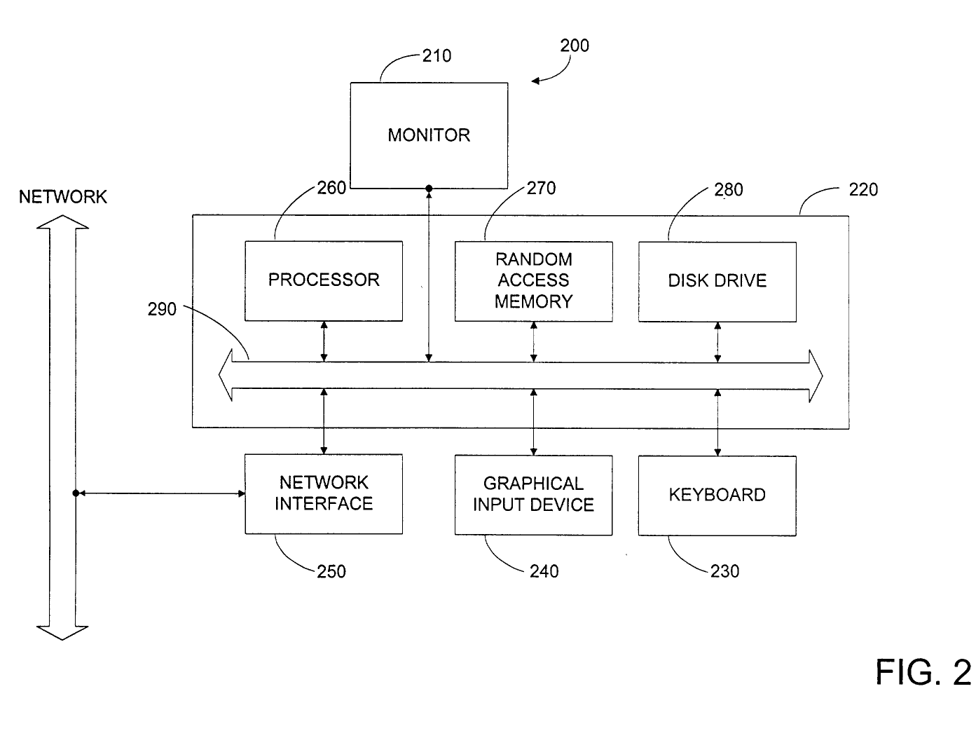

FIG. 2 is a block diagram of typical computer system 200 according to embodiments of the present invention. Embodiments of systems 100-120 and servers 130-140, 170, and 180, may be embodied as computer system 200.

In the present embodiment, computer system 200 typically includes a monitor 210, computer 220, a keyboard 230, a user input device 240, a network interface 250, and the like.

In the present embodiment, user input device 240 is typically embodied as a computer mouse, a trackball, a track pad, wireless remote, and the like. User input device 240 typically allows a user to select objects, icons, text and the like that appear on the monitor 210.

Embodiments of network interface 250 typically include an Ethernet card, a modem (telephone, satellite, cable, ISDN), (asynchronous) digital subscriber line (DSL) unit, and the like. Network interface 250 are typically coupled to a computer network as shown. In other embodiments, network interface 250 may be physically integrated on the motherboard of computer 220, may be a software program, such as soft DSL, or the like.

Computer 220 typically includes familiar computer components such as a processor 260, and memory storage devices, such as a random access memory (RAM) 270, disk drives 280, and system bus 290 interconnecting the above components.

In one embodiment, computer 220 is a PC compatible computer having an ×

86 based microprocessor, such as an Athlon™ microprocessor from Advanced Micro Devices, Inc. Further, in the present embodiment, computer 220 typically includes a Windows™ operating system such as Windows ME, WindowsNT, or the like from Microsoft Corporation.

RAM 270 and disk drive 280 are examples of tangible media for storage of data, audio/video files, computer programs, browser software, embodiments of the herein described invention, applet interpreters or compilers, virtual machines, web pages, databases such as Oracle 8i, and the like. Other types of tangible media include floppy disks, removable hard disks, optical storage media such as CD-ROMS and bar codes, semiconductor memories such as flash memories, read-only-memories (ROMS), battery-backed volatile memories, and the like. In embodiments of the present invention, such as set top boxes, mass storage, such as disk drive 280, and the like may be dispensed with.

In the present embodiment, computer system 200 may also include software that enables communications over a network such as the HTTP, TCP/IP, RTP/RTSP protocols, and the like. In alternative embodiments of the present invention, other communications software and transfer protocols may also be used, for example IPX, UDP or the like.

FIG. 2 is representative of types of computer systems for embodying the present invention. It will be readily apparent to one of ordinary skill in the art that many other hardware and software configurations are suitable for use with the present invention. For example, other types of processors are contemplated, such as Pentium™ class, Celeron™-class, or other microprocessors from Intel Corporation; PowerPC G3™, G4™ microprocessors from Motorola, Inc.; Crusoe™ microprocessors from Transmeta, and the like. Further, other types of operating systems are contemplated, such as Solaris, LINUX, UNIX, MAC OS from Apple Computer Corporation, BeOS, and the like. Additionally the specific configuration of the hardware and software will vary when computer system 200 is configured as client system 110, as promotion server 150, or the like. In still other embodiments, set top boxes such as the PS2, X-Box, WebTV, and the like may also be used.

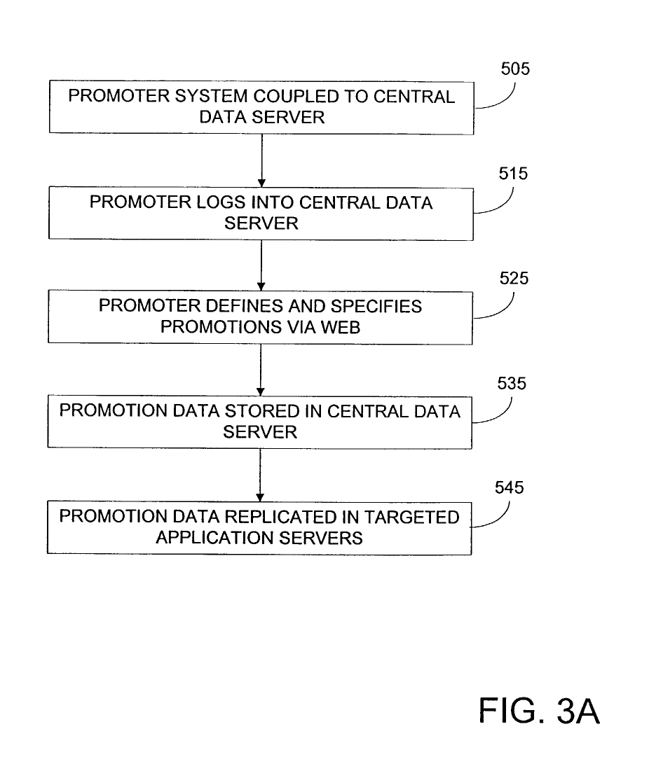

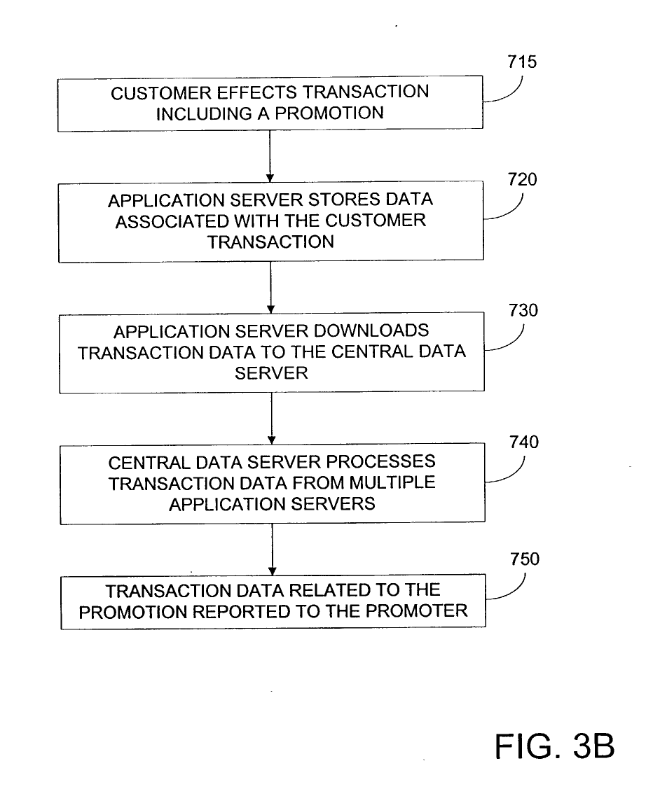

FIGS. 3A-B illustrate a block diagram of a flow chart according to an embodiment of the present invention. In particular, FIGS. 3A-B illustrates the process of defining and reporting usage of a promotion with reference to the elements in FIG. 1.

Initially, a user (promoter) at promoter system 100 (or a merchant system) is coupled to central data server 150, step 505. In one embodiment of the invention, promoter system 100 is coupled to data server 150 via computer network 160. In such embodiments, conventional network protocols may be used such as TCP/IP, IPX, and the like. Other types of networks such as VPN or wireless networks may also be used. In other embodiments, promoter system 100 may be coupled to data server 150 through other direct means such as dial-up lines, wireless connections, dedicated connections and the like. In one embodiment, promoter system 100 uses a web browser to request and retrieve a web page hosted by data server 150.

Once coupled to data server 150, the promoter at promoter system 100 typically logs into their account, step 515. The login process may include the promoter entering their user name and password, PIN, or the like on a Web form.

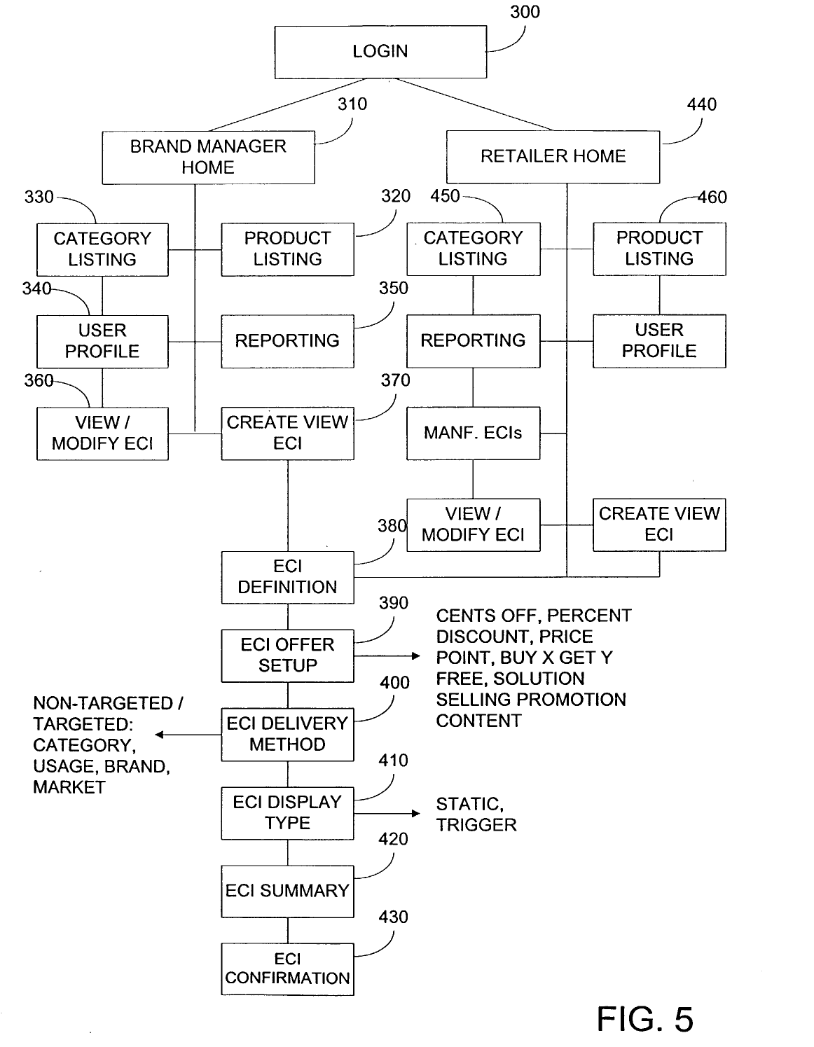

After successfully logging, in the promoter creates and defines the promotion, step 525. As will be described below in FIG. 5, various software processes with data server 150 allows the promoter to define the promotion type, delivery method, display type, and the like. The data is typically entered via a series of web form and submissions. In this embodiment, the promotion is stored within data server 150, step 535. Data structures used by data server 150 for storage of the promotion data, and other related data was discussed above.

In the present embodiment, the promotion is then distributed to application servers, such as application server 180, step 545. In one embodiment, promotions are distributed to all application servers. In another embodiment, the promotion may only specify that the promotion is distributed to only application servers coupled to particular merchant servers, such as only PeaPod.com. In alternative embodiments, promotions are not limited to distribution to certain application servers. In this embodiment, the data entered by the promoter is packaged within a data structure, (i.e. a set of promotion data) and downloaded to an application server. Each set of promotion data is typically small, on the order of hundreds of bytes of data.

As disclosed in the disclosures, incorporated by reference, application servers and merchant servers subsequently display promotions to consumers and receive use of the promotions. In the present example, when the consumer effects a transaction, step 715 (a promotion usage condition) application server 180 stores data associated with the transaction, step 720. For example, application server 180 may record the items of the shopping cart, the dollar amount of the items, the number of items, the customer identification and/or customer demographic data provided by merchant server 180, shopping time, the promotions viewed, the promotions used by the customer and the like. Data server 150 collects data from applications servers running the promotions, and processes such data, step 730.

Periodically, application server 180 contacts data server 150 and downloads the processed transaction data from typically more than one customer, step 740. For example, application server 180 may contact central data server 150 every day, once every week, or the like and download data associated with transactions that have occurred since the last time they were in contact. In this embodiment, the data passed back may include the customer's shopping cart specifics, the customer's demographics, promotions accepted, and the like.

Periodically, promoter server 100 contacts data server 150 and retrieves reports describing the promotion's progress and/or success, step 750. In this embodiment, the promoter at promoter server may want to track the progress of their promotions every day, every two days, every week, and the like. As above, in this embodiment, the reports passed back may include shopping cart contents of each customer, the customer's demographics, the dollar amount of the promotion used, and the like.

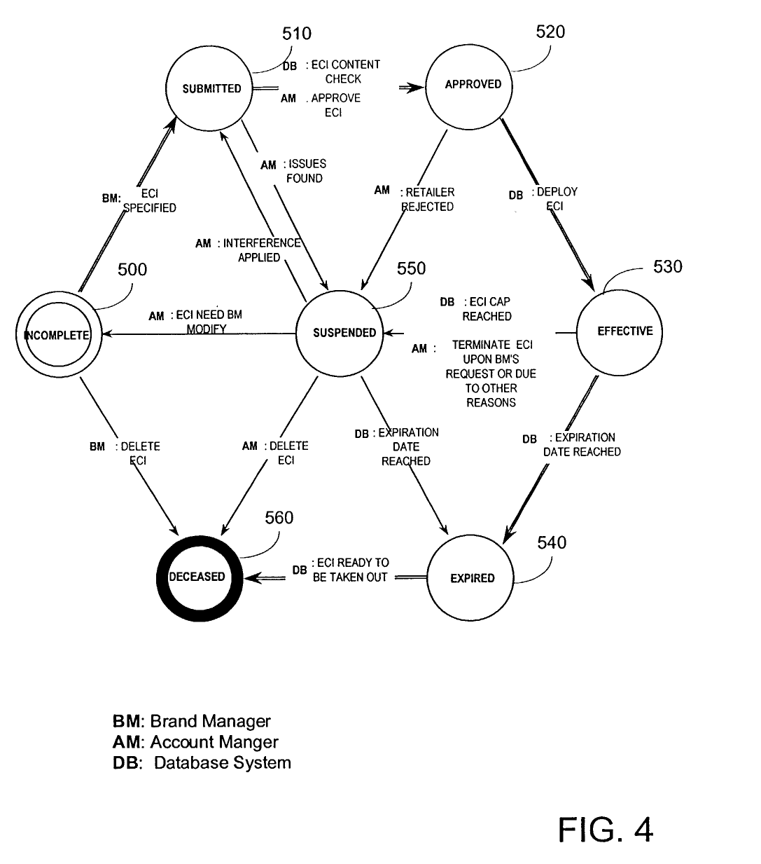

FIG. 4 illustrates a logical state diagram according to an embodiment of the present invention. In particular, FIG. 4 illustrates a logical state diagram of a promotion within centralized data server 150.

In state 500 a promoter at promotion server 100 defines and prepares a promotion. After preparation, the promotion is submitted for approval and distribution, state 510. From state 510, if the promotion is approved for distribution, the promotion state moves to state 520.

In this embodiment, promotions have an effective date and an expiration date. After the approval state, when the effective date of the promotion is reached, the state machine moves to state 530. In this state, the promotion is propagated to one or more application servers 170. The state machine then moves to state 540. In state 540, when the expiration date of the promotion is reached, the state machine moves to step 560, and the promotion is disabled.

From states 510, 520, or 530, the promotion may be suspended. In such cases, the state machine moves to state 550. From state 550, the promotion may be modified or disabled. When the promotion is to be modified, the state machine moves back to state 500, and if the promotion is disabled, the state machine moves to state 560.

FIG. 5 illustrates a block diagram according to an embodiment of the present invention. In particular, FIG. 5 illustrates the logical software architecture of centralized data server 150. In this embodiment, users (promoters) at promotion server 100 and users (merchants) at merchant servers 130 can specify and/or view real-time promotions and data related to promotions.

In FIG. 5, a login process 300 is provided that authenticates and verifies the user. In this case, promoters and merchants are typically pre-assigned accounts with data server 150 after agreeing to the real-time promotion service. In other embodiments, such users can sign-up on-line.

When the user is identified as a promoter, the user is directed to the brand manager home 310. From there, the promoter is given a variety of options. For example, the promoter can define and view products available for promotional activity with a product listing process 320. The promoter can also define and view categories of product available for promotional activity with a category listing process 330, e.g. a product/service categorization scheme. In process 340, the user can define and change the promoter profile, for example, brand manager name, contact information, and the like.

In reporting process 350, the promoter can review report data. In one embodiment, the report data includes which promotions were used by consumers, the demographics of the consumer, the number of promotion impressions, the items purchased, or the like along with the promotion, and the like. In additional embodiments, other types of data that may be provided include the amount of promotion provided, category views, trigger views, and the like, as will be described further below. Such data is useful to the promoter in determining the success of different promotions, different promotion strategies, the success of promotion targeting, and the like.

Process 360 allows the promoter to view and modify the various parameters of promotions that are created in processes 370-420.

In the present embodiment, processes 370 and 380 allow the promoter to create and define a promotion. Process 380 includes sub-processes 390-430. In the present embodiment, sub-process 380 allows the promoter to setup administrative details of the promotion. In this example, the promoter may specify an offer tracking code, a program number for the promotion (e.g. to identify a “back to school” promotional campaign), a timing cycle, and merchants or retailers that will participate in the promotion. In other embodiments, additional administrative details may be specified including a phenotype of the promotion, a description of the promotion, promotional limitations, effective date, expiration date, a URL including additional promotional content (e.g. a web-site including recipes), and the like.

In this embodiment, sub-process 390 allows the promoter to specify the actual promotion. The promotion typically includes an offer type, a product bundle, and an amount. In this example, typical offer types includes cents off, percent discount, price point, buy X get Y free, free value (e.g. product samples), additional promotional content, and the like.

A product bundle typically refers to products that must be purchased together in order to trigger the promotion. For example, a bundle may include purchase of ketchup, mustard, and relish. In this embodiment, the product bundle may include up to three products, although in other embodiments, a greater number of products may be bundled.

In this example, the number of times a specific promotion may be used can be specified by the promoter. For example, the maximum number of promotion uses may be limited by the total number per merchant/retailer, the total number for the promotional campaign, and/or the number of promotion uses per shopping trip (e.g. one per visit). Additionally, the maximum number of dollars used in the campaign may be specified, and the like. These limitations to the number of times a promotion may be used may be specified for each of the offer types discussed above.

In this embodiment, sub-process 400 allows the promoter to specify a delivery method for the promotion. In particular, this process allows the promoter to target the promotion. In this example, four types of targeting methods are provided: category, usage, brand, and market. Category targeting targets promotions based upon consumer consumption of products within that category; usage targeting targets promotions based upon consumer consumption of specific product; brand targeting targets promotions based upon a percentage of purchases of a specific brand; and market targeting targets markets based upon geography. In other embodiments, other types of promotion targeting may include targeting based upon demographic data, income, and the like. In other embodiments, targeting may be combined with any of the above types of offers.

Sub-process 410, in FIG. 5, allows the promoter to specify a promotion display type. In particular, this process allows the promoter select between static or triggered display. In this example, static display is when the promotion is displayed to a consumer in a specific “aisle” or category in the store. Further, triggered display is when the promotion is displayed in response to particular actions of the consumer. For example, when the consumer has placed particular items in her shopping cart, when the consumer shopping patterns have met certain constraints, and the like.

Sub-processes 420 and 430 allow the promoter to preview the specified promotion and confirm the promotion. As will be described below, after confirmation of the promotion is received in data server 150, data server 150 distributes the promotion to the application servers associated with merchant servers specified by the promoter.

In FIG. 5, if the user is identified as a retailer, the user is directed to the retail manager home 440. From there, the retailer, such as an on-line grocery store, or other on-line commerce site, is given a variety of options similar to the promoter or brand manager. Importantly, the retailer can define and view categories of goods or services offered with process 450, e.g. a product/service categorization scheme, and populate the categories with products with process 460. Other processes are also available to the retailer as illustrated.

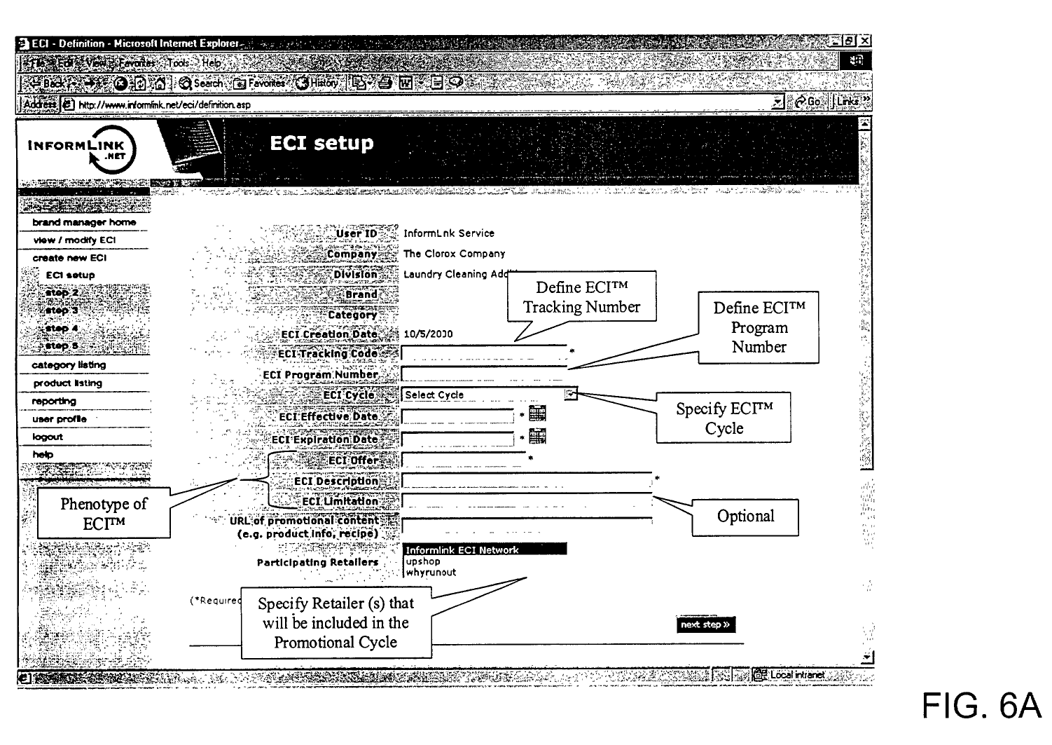

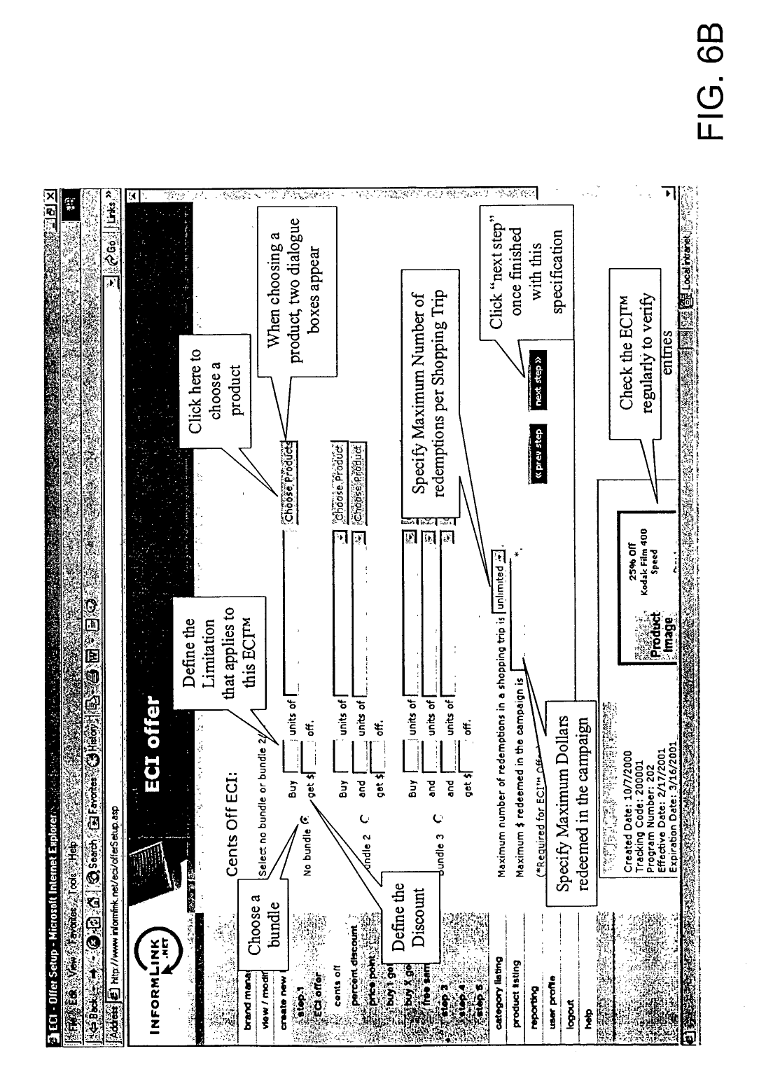

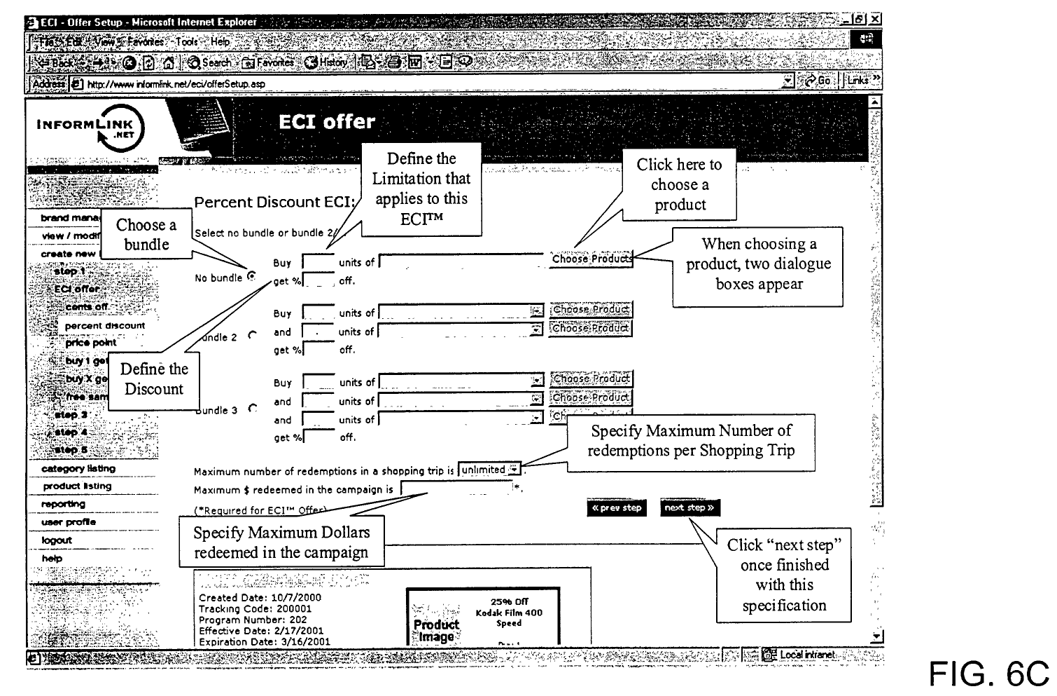

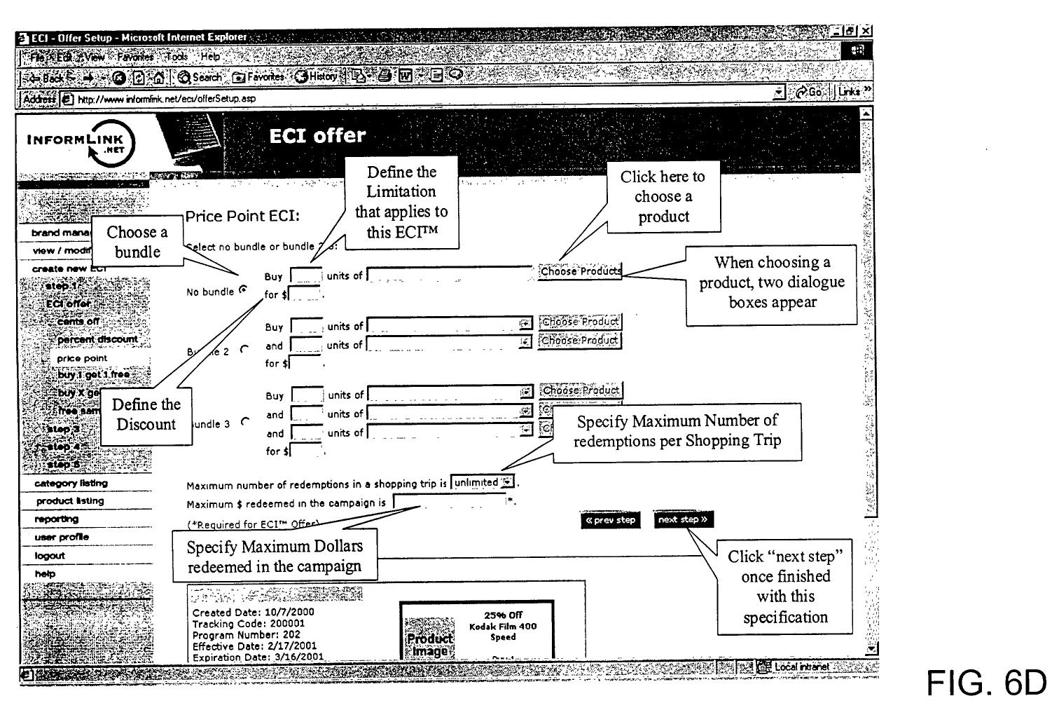

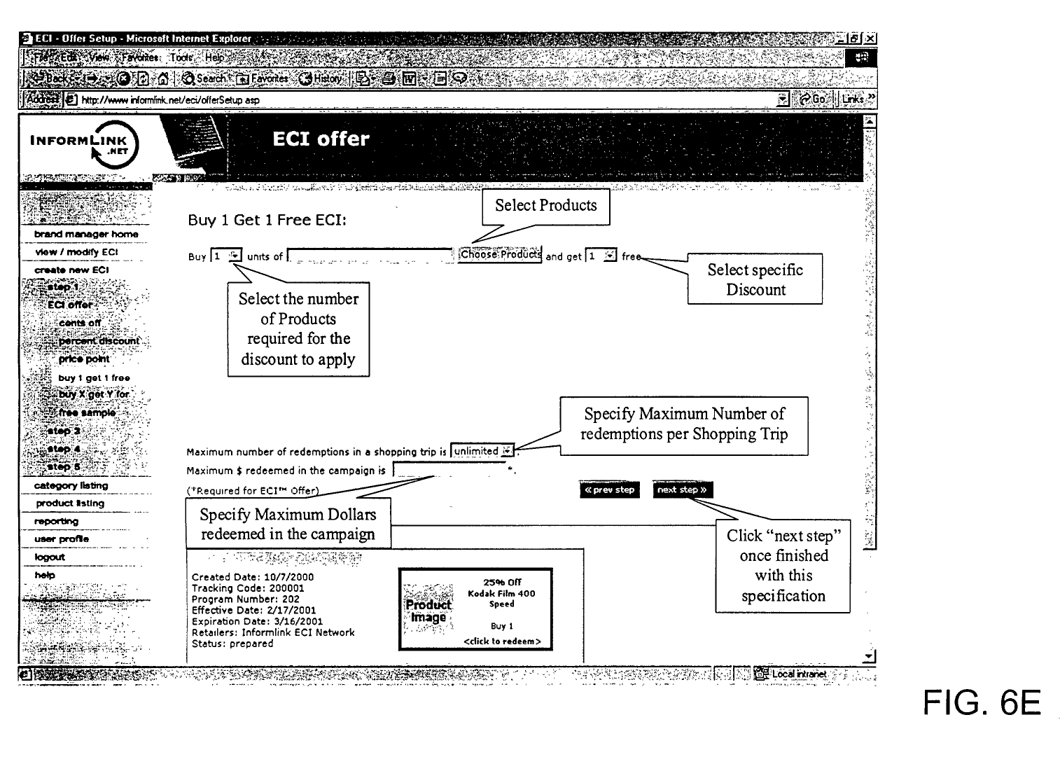

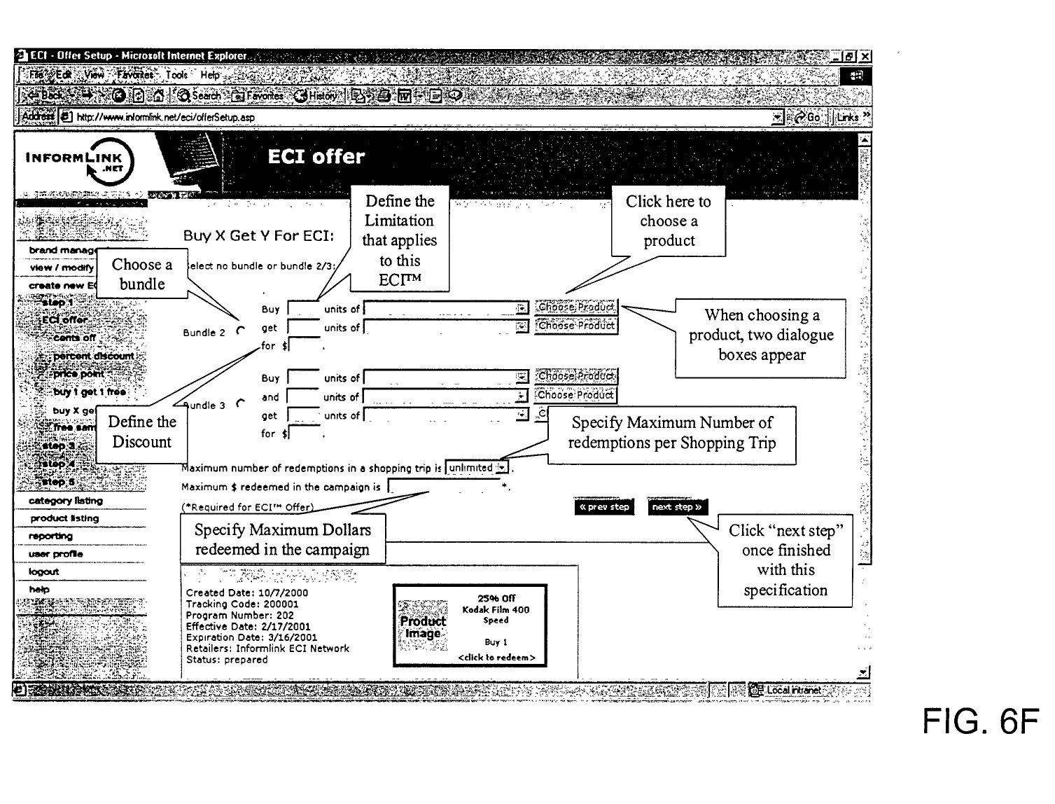

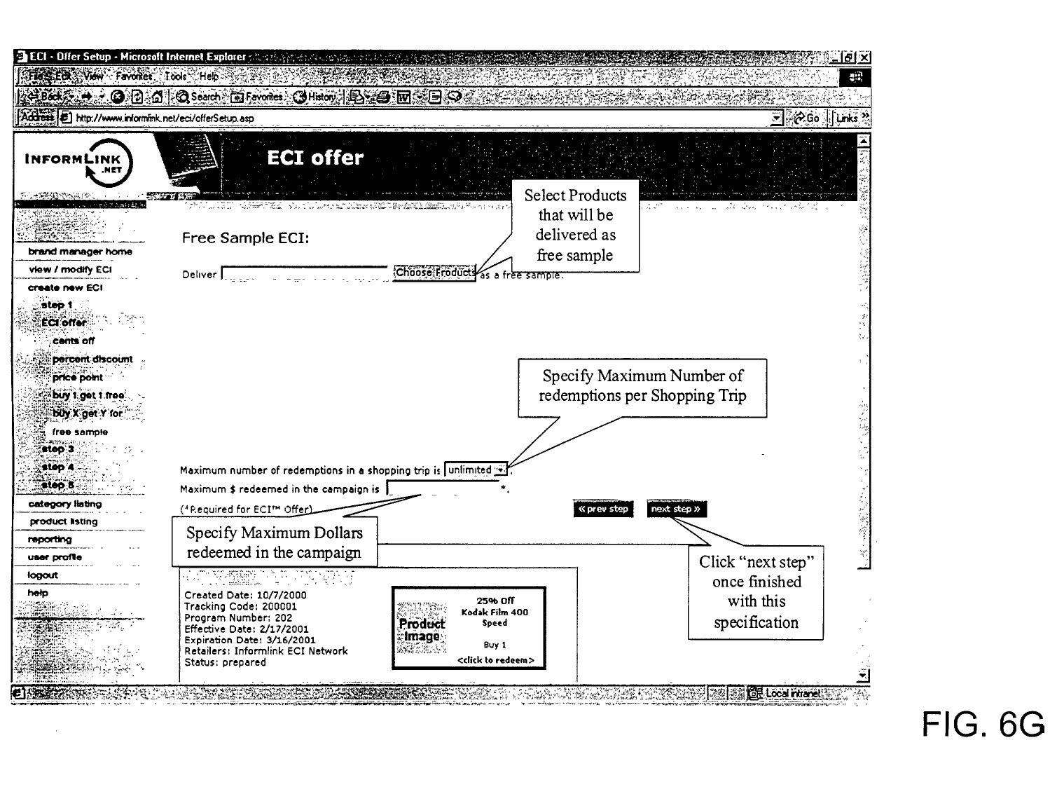

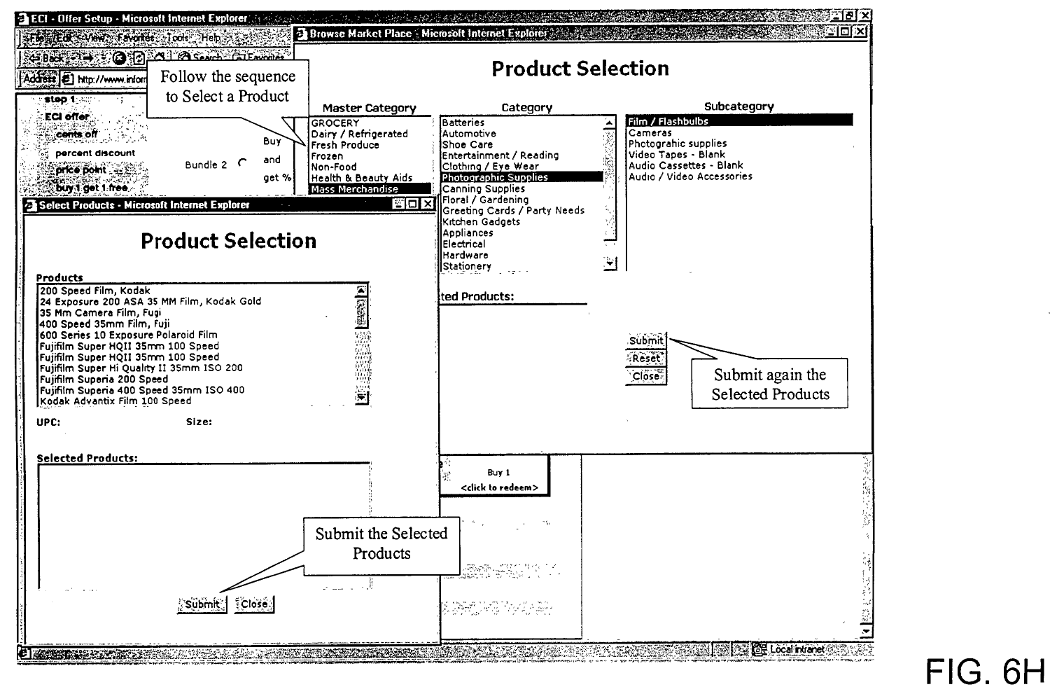

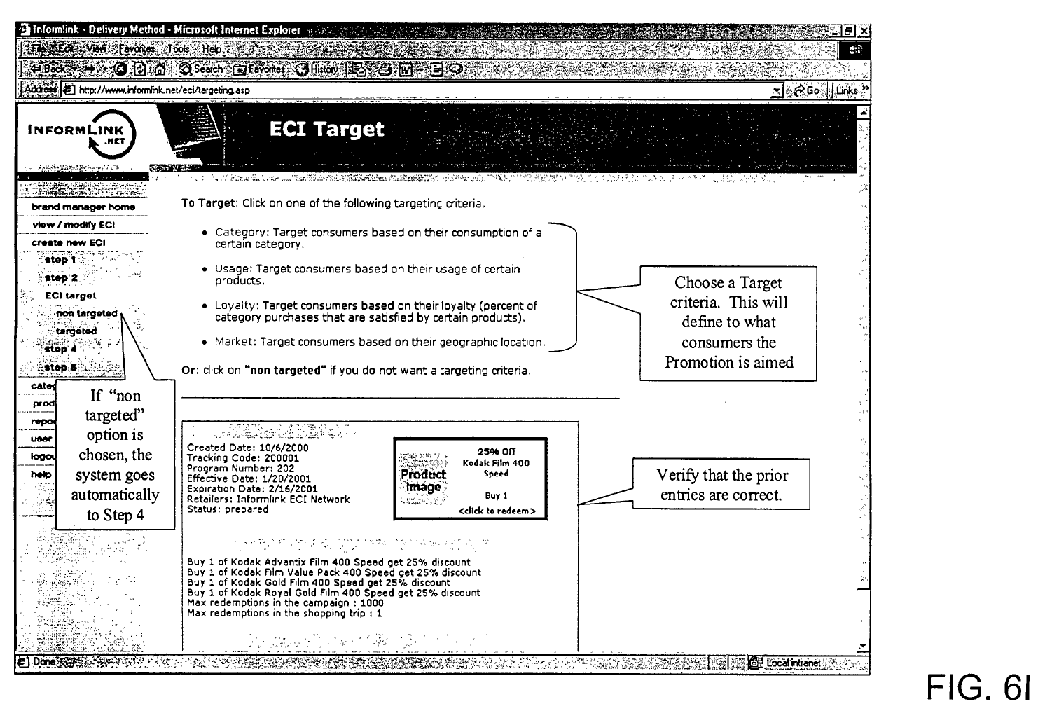

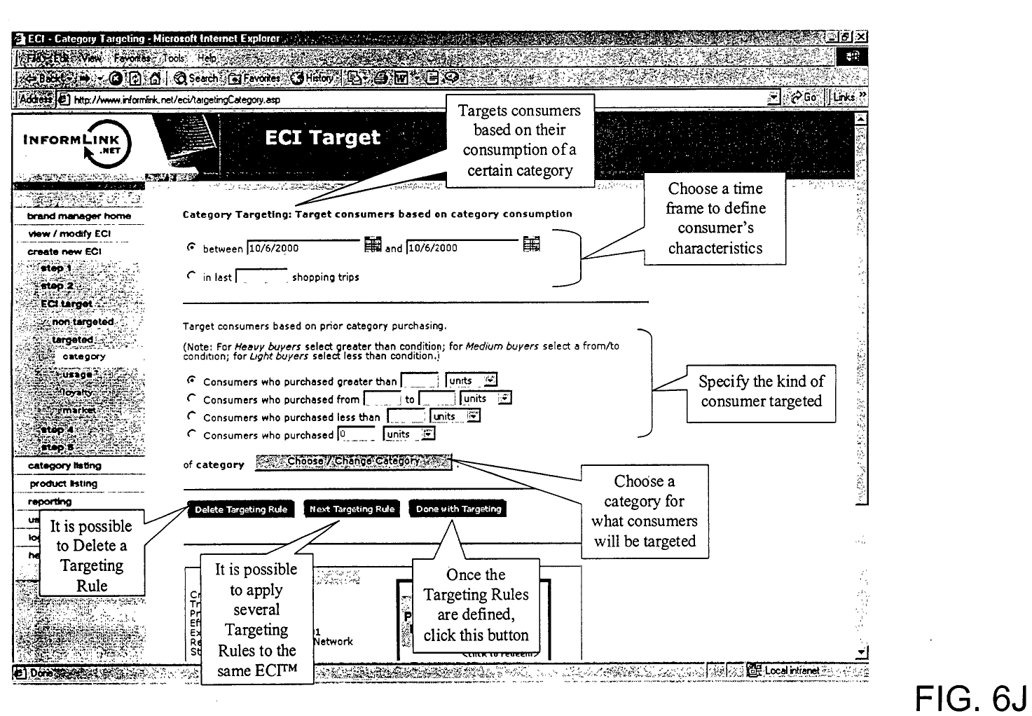

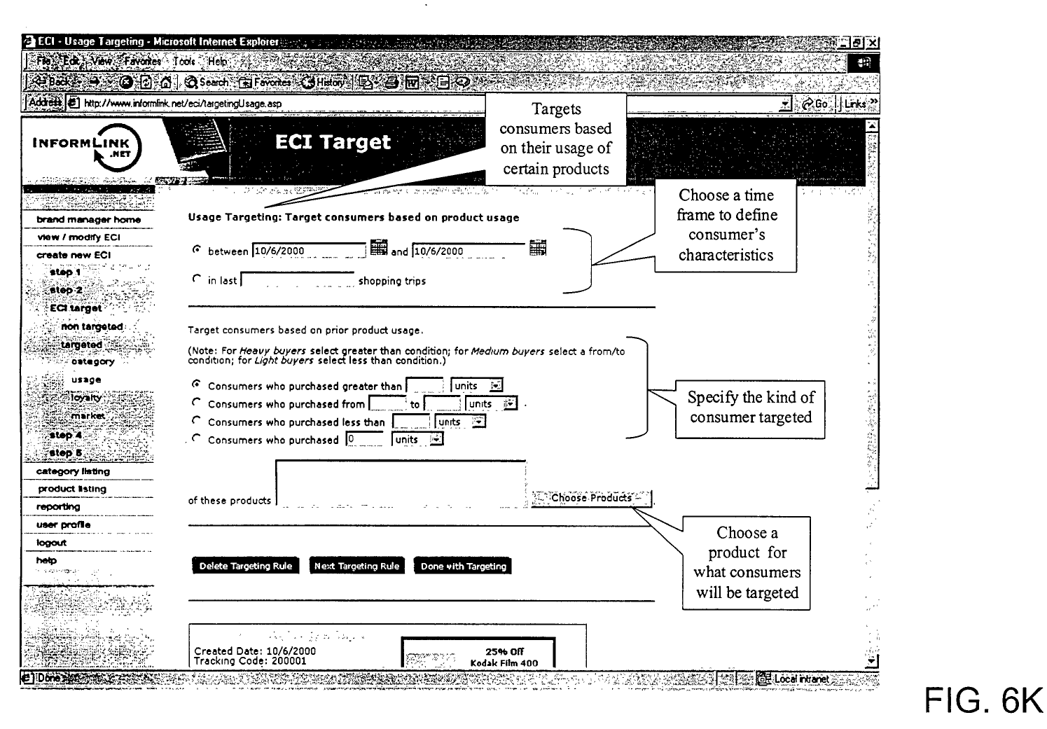

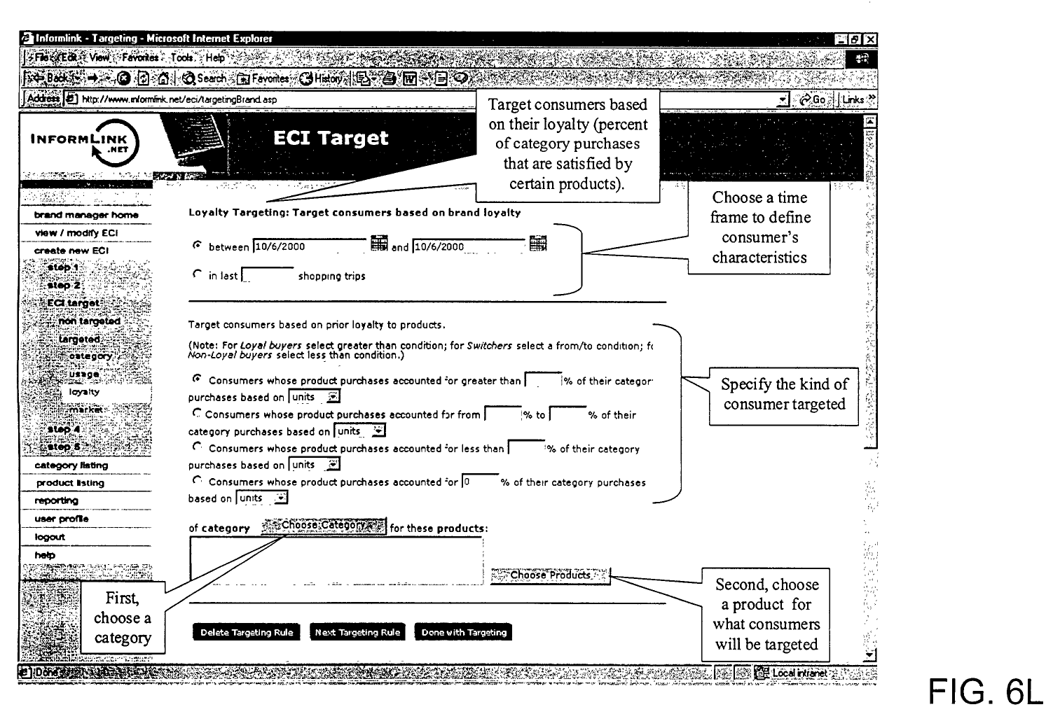

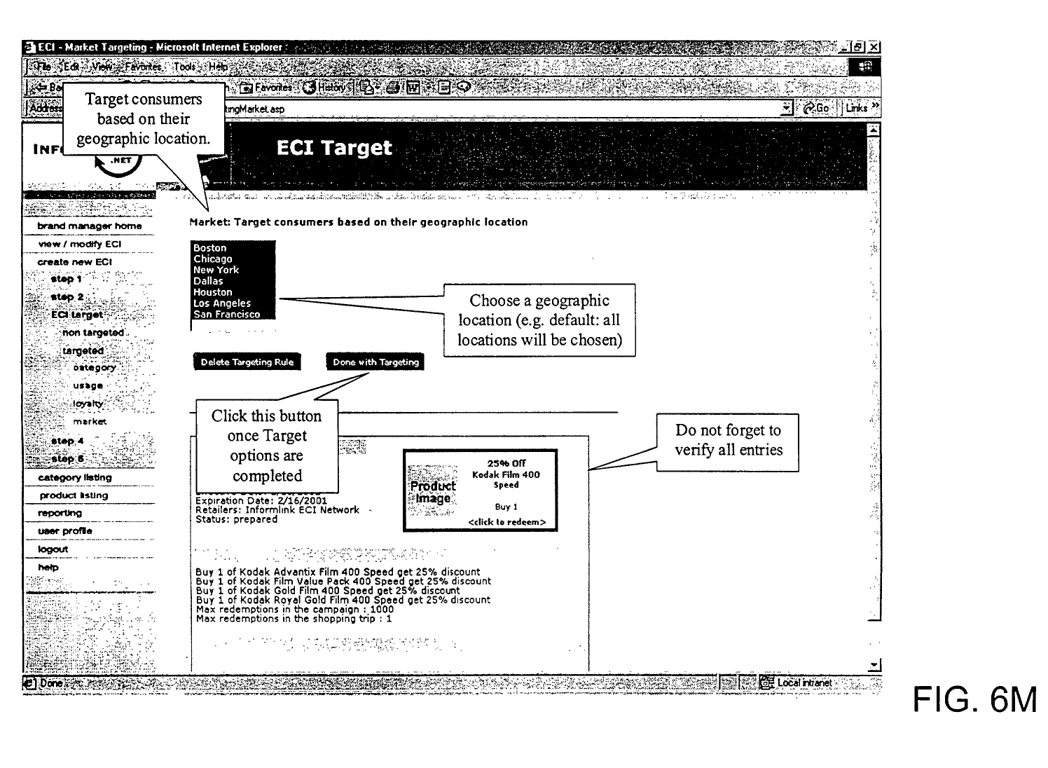

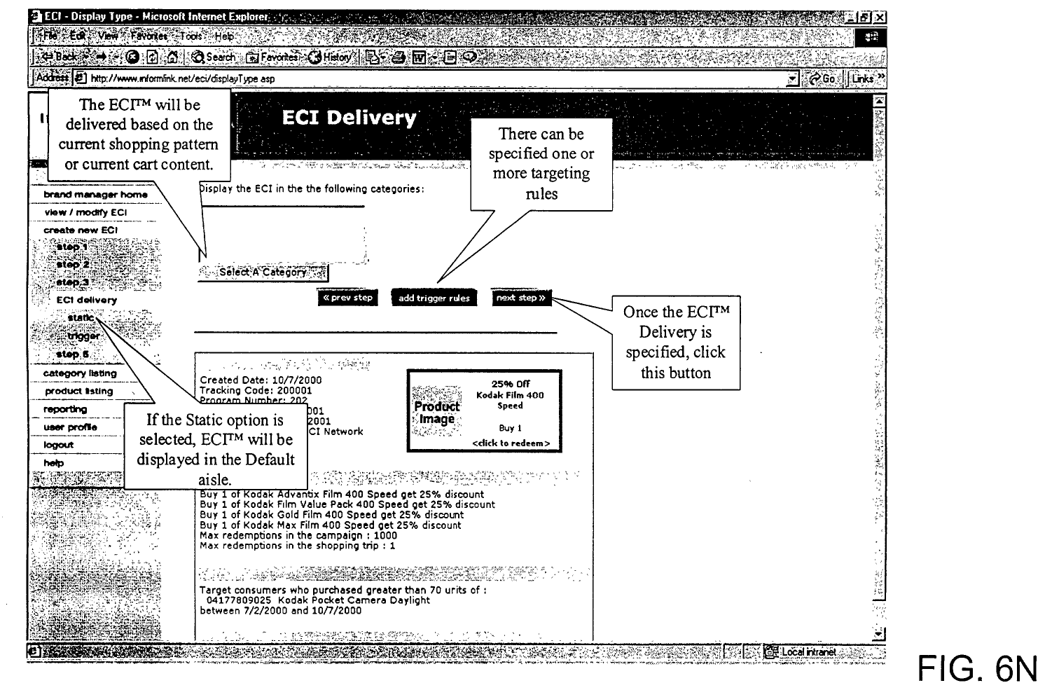

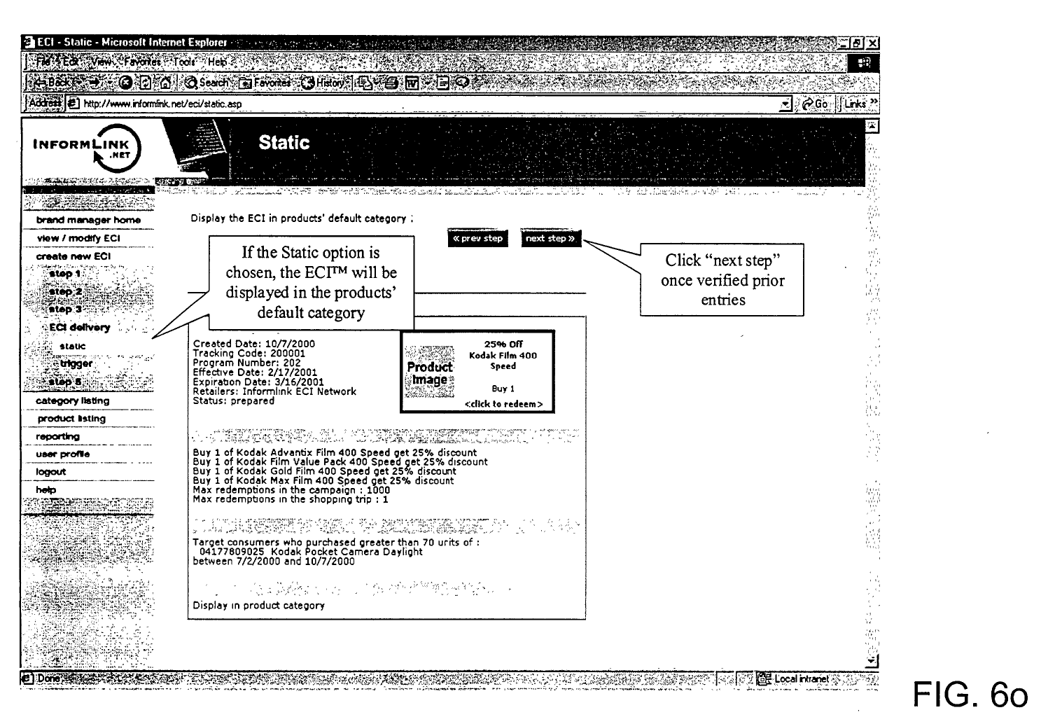

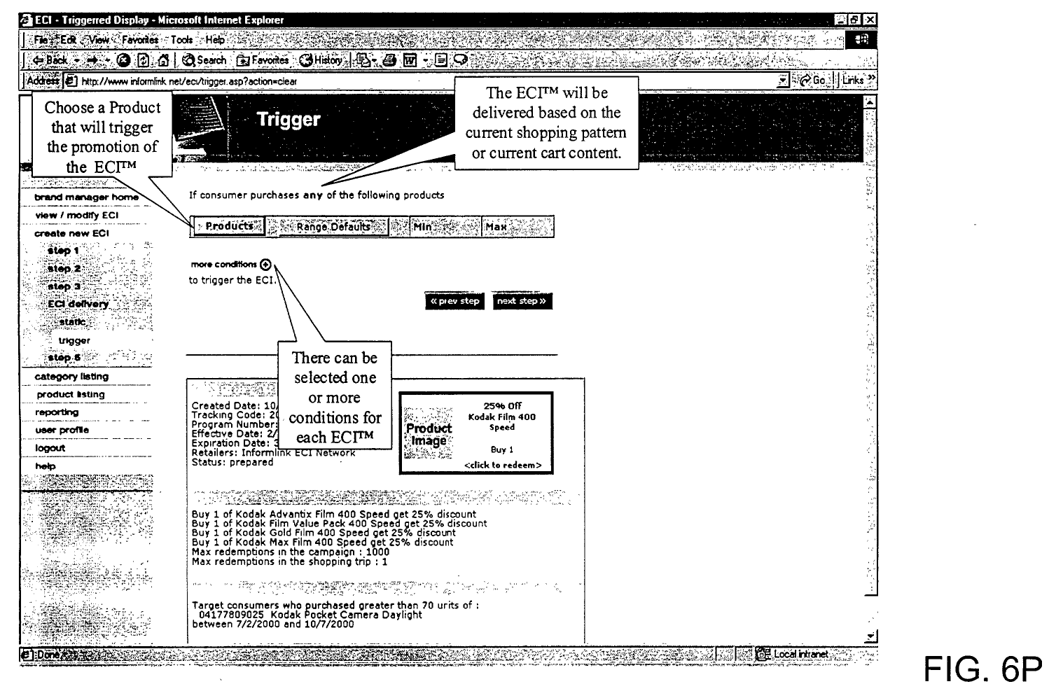

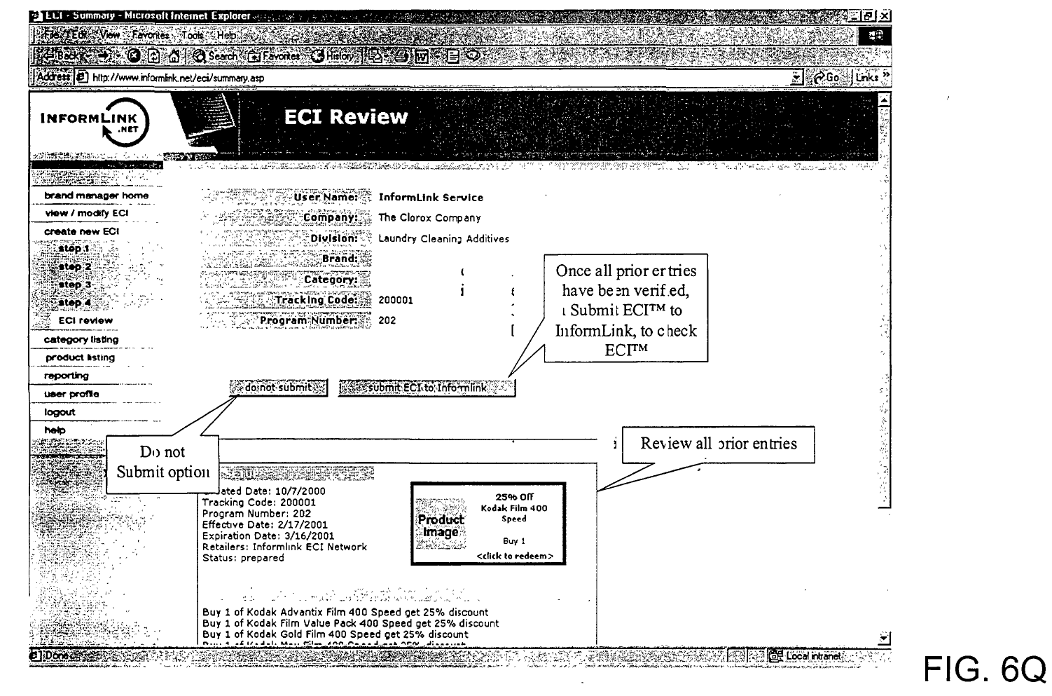

FIGS. 6A-Q illustrate graphical user interfaces according to embodiments of the present invention. More specifically, FIGS. 6A-Q illustrate graphical user interfaces (GUIs) displayed to promotion managers, or the like that allow such managers to define and review promotions, and allow such managers to view promotion results. In the present embodiment, the graphical user interfaces are configured to be displayed in conjunction with a web browser such as Netscape Navigator, or the like. The following GUIs are typically displayed to the promoter after the promoter successful logs into central data server 150.

FIG. 6A illustrates a GUI according to an embodiment of the present invention. In particular, FIG. 6A illustrates a GUI allowing promoters, or the like to create or setup promotions.

In this embodiment, the setup page allows the promoter to enter basic information regarding the promotion. For example, as illustrated in FIG. 6A, the GUI may prompt the promoter to enter the following information:

Offer Tracking Code—A unique number to identify the promotion.

Program Number—A number that is used to group promotions (ECIs) together. For example: A series of promotions may use the same promotion for a common promotion or theme (such as a “Back to School” promotion). The program number allows promoters to receive reports regarding all promotion activity per campaign under a master number.

ECI™ (Promotion) Cycle—the period during which many promotion's are effective and consumers can redeem them while doing online shopping. Promotion cycle could take many values like 1 week or 4 weeks. Different promotion cycles could be co-existing in the system but each promotion can only be associated to one promotion cycle. promotion's effective date and Expiration date must be the beginning and the end of one promotion cycle.

Effective Date—A date when the promotion becomes effective. The date may be selected from a starting cycle from a pull-down list.

Expiration Date—A date when the promotion expires. The date may be selected from an ending cycle from a pull-down list.

Title—Typically a human readable title (up to 15 characters) for the top line of the promotion, e.g. Save $2.00.

Description—A description (up to 40 characters) for the promotion, e.g. Any 12-oz. Soft Drink.

A restriction/limitation—A limit size or quantity of products, or the like (up to 30 characters), e.g. Limit 2 per purchase.

URL of promotional Content—A URL that the customer/consumer may follow for additional information about the promotion, such as product information, recipes, or the like.

Participating Retailers—A selection of merchants or retailers that will participate in the promotion. In this embodiment, the entire InformLink ECI™ Network is the default.

After completing the required fields, an Offer Setup typically page appears. The information entered by the promoter is typically summarized on this page. The data may modified by returning to the previous page before submitting the promotion, or by selecting the View/Modify promotion option from the menu after the promotion has been submitted.

FIGS. 6B-H illustrate GUIs according to an embodiment of the present invention. In particular, FIGS. 6B-H illustrate GUIs allowing promoters, or the like to select an offer type for the promotions, a product bundle for the offer type, and a maximum amount of redemptions for the promotion.

More particularly, as illustrated, the GUIs may prompt the promoter to select an offer type from the following offer types:

Cents off—This is used for giving a specific dollar amount of a product or groups of products, e.g.: Buy any widget and get $.50 off; or, buy any widget and any trinket and save $1.00. It should be understood that such an discount may refer to discounts in other currencies, and may also refer to reward points, such as Airline Miles, “DoubleClick” points, club points, or the like. FIG. 6B.

Percent Discount—This is used to give a certain percentage discount off the purchase price, e.g.: Buy any widgets and get 10% off. FIG. 6C.

Price Point—This is used to promote an item or items at a defined price, e.g.: Buy any widget for $2.99. FIG. 6D. Again, other types of “point” systems may also be used.

Buy X Get Y Free/Free Value (Buy X, Get Y for Z)—This offer type is used for running a buy X get Y for free promotion, for giving away a free sample, or for giving a special package price. For example: Buy three widgets get one for free (FIG. 6E); buy one widget get one new and improved widget for free (FIG. 6F); buy six widgets for the price of four widgets; free widget (FIG. 6G).

Promotional Content—This offer type is used for displaying recipes or product information, or other promotion content. This can be used alone or in conjunction with another offer type, described above. In this embodiment, a URL of a link and a text description are required.

Bundle Type—In most of the offer types described above, the promoter may apply the promotion to more than one product (a bundle of products). As can be seen from the GUIs, the bundles may be more than one of a particular product, products from two different product categories, two different products, and the like. In the present embodiment, the available bundles include:

No Bundle—Promotions that are only pertinent to the purchase of one product.

Bundle 2—Promotions that include 2 products that must both be purchased in the same shopping trip.

Bundle 3—Promotions that include 3 products that must all be purchased in the same shopping trip.

In the present embodiment, the promoter specifies a bundle with the following process:

1. Clicking the radio button next to the bundle type desired (No Bundle, Bundle 2, Bundle 3);

2. Entering a Buy number (the amount of products the consumer must purchase) and a Get number (the cents/percent/price deducted from the product) for the bundle.

3. Clicking Pick Products. The Product Selection page then typically appears. FIG. 6H.

4. Selecting a Product Category. In this embodiment, the promoter initially selects a master category of products. In response, a category of products appear in a category column. Selection of a category leads the promoter to a sub-category, and the like. In this embodiment, when the sub-category includes no further sub-categories, a list of the products is displayed to the promoter.

5. Selecting a Product (e.g. Gerber Juice Apple). In this embodiment, the promoter selects one or more products from the product list to be included in the promotion or the bundle promotion.

6. Clicking Submit, then click Submit again from the Product Selection page. The products selected are then displayed.

Exemplary bundles may be: “Buy one 16 oz ketchup, one 8 oz mustard, and one 8 oz relish and get $2 off”; another bundle may specify the same bundle of products but specify that the consumer is given free hotdog buns; or the like.

The promoter may also specify a maximum number of promotion usage per shopping trip. In most of the offer types described above, the promoter may have limitations with regards to number of times a promotion is used during a shopping trip. For example, the promoter may specify that the consumer/shopper can take advantage of the promotion once per shopping trip, or an unlimited number per shopping trip, or the like. In other embodiments, consumers may be limited to one promotion usage per person per month, or the like.

The promoter may also specify a maximum number of dollars, or the like, redeemed during the promotion. In most of the offer types described above, the promoter may have limitations with regards to total number of times the promotions is taken advantage of by consumers. Further, the maximum number of dollar benefit to consumers may be specified. In other embodiments, the maximum number may be applied per region, for example, $100,000 worth of promotions to zip code 22202, $50,000 worth of promotions to zip code 01801, and the like. In still other embodiments, other promotion limitations can be envisioned in light of the present patent disclosure.

FIGS. 6I-M illustrate GUIs according to an embodiment of the present invention. In particular, FIGS. 6I-M illustrate GUIs allowing promoters, or the like to select a delivery method or target delivery method for the promotion.

More particularly, as illustrated, the GUIs may prompt the promoter to select an appropriate delivery method for the promotion. FIG. 6I. In the present embodiment, the delivery method may be targeted or non-targeted. If a promotion is non-targeted, the promotion is not targeted at a specific group of consumers. If the promotion is targeted, it allows the promoter to specify groups of consumers to target. The targeting criteria may include:

Category—targeting groups of consumers by their consumption of products within a certain product category (e.g. batteries).

Usage—targeting groups of consumers by their consumption of certain products, (e.g. AA batteries).

Brand—targeting consumers based on the percent of purchases in a category that is their brand (e.g. Duracell batteries).

Market—targeting consumers based on their geographic location (e.g. Chicago).

In the present embodiment, one or more targeting methods may be invoked for any promotion. For example, the promoter can select Category Targeting in conjunction with Usage and Market targeting. Further details regarding the types of targeting are discussed below.

In the present embodiment, to define a target category (FIG. 6J) or target usage (FIG. 6K) for a promotion, the following steps may be performed:

1. Selecting a targeting option from the target options:

Target users who purchase between X and Y units/dollars per cycle of the targeted category/product usage;

Target heavy users who purchase over Z units/dollars per cycle of the targeted category/product usage;

Target medium users who purchase between A and B units/dollars per cycle, B<Z of the targeted category/product usage; and

Target light users who purchase between 0 and C units/dollars per cycle, C<A of the targeted category/product usage.

2. Selecting a “target category” (FIG. 6J) or “targeted product(s)” (FIG. 6K).

3. Selecting a calendar targeting period, or a period covering the last X number of shopping trips.

In the present embodiment, to define a target brand (FIG. 6L), the following steps may be performed:

1. Selecting a targeting option from the target options:

Target users who purchase between X % and Y % of a targeted brand per units/dollars per cycle;

Target loyal users who purchase over 89% of a targeted brand per units/dollars per cycle;

Target “switch” users who purchase between 20% and 80% of a targeted brand per units/dollars per cycle; and

Target competitor users who purchase less than 20% of a targeted brand per units/dollars per cycle.

2. Selecting a target brand.

3. Selecting a calendar targeting-period, or a period covering the last X number of shopping trips.

In the present embodiment, to define a targeted geographical consumer, FIG. 6M, the promoter may select from the geographic locations displayed. Alternatively, the promoter may select from a list of zip codes, or the like.

FIGS. 6N-P illustrate GUIs according to an embodiment of the present invention. In particular, FIGS. 6N-P illustrate GUIs allowing promoters, or the like to select a display type for the promotion.

More particularly, as illustrated, the GUIs may prompt the promoter to select when the promotion is displayed to a targeted consumer. FIG. 6N. In the present embodiment, the display may be static or triggered. If a promotion is static, the promotion is displayed to the consumer when the consumer “browses” or “shops” within a particular category of products. For example, promotions for Kodak film may be displayed to the user when the user shops the product category “film.” FIG. 6o.

Alternatively, the promotion may be triggered by the contents of the consumer's “shopping cart” or equivalent. FIG. 6P. As an example, when the consumer places Kodak film in her shopping basket, a promotion for Fuji film may be triggered and displayed to the consumer. In the present embodiment, more than one condition may be used for triggering the display of particular promotions to the user.

FIG. 6Q illustrates a GUIs according to an embodiment of the present invention. In particular, FIG. 6Q illustrate a GUI that allows promoters, or the like to review the various conditions of a promotion and to make any necessary changes thereto. As disclosed above, if satisfactory, the promoter may formally submit the specification of the promotion to central data server 150.

As discussed in FIG. 5, above, embodiments of the present invention include a reporting module for creating retailer and product promotion activity reports. Such reports are used by Brand or Retail managers to track the individual progress of particular promotions. In the present example, reports can be viewed via InformLink.Net, Microsoft Excel, Microsoft Excel 2000 Viewer, or the like.

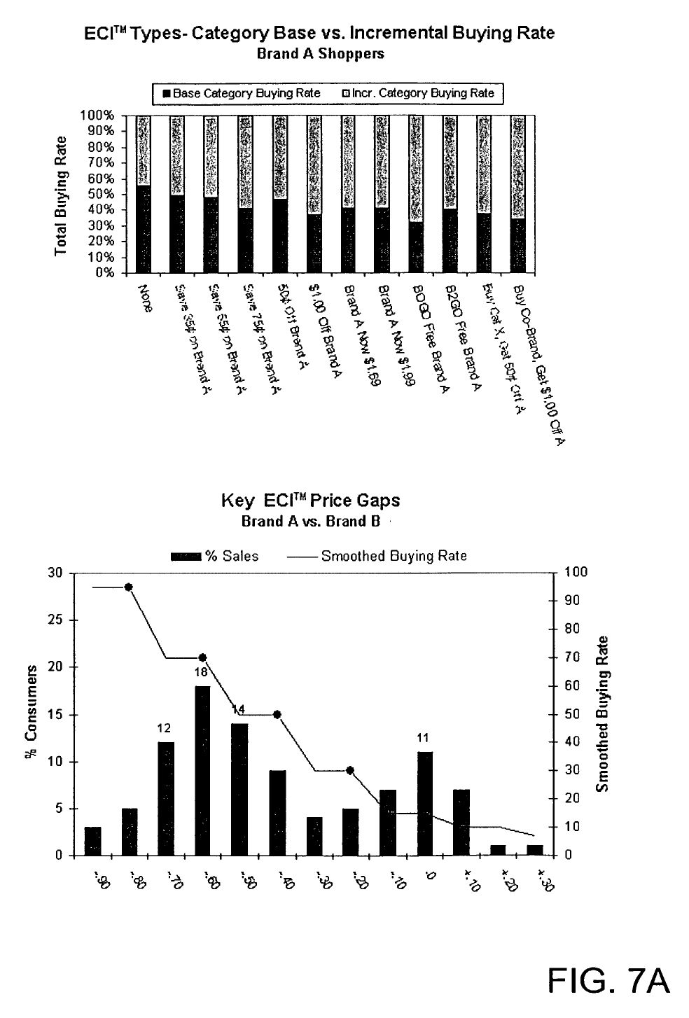

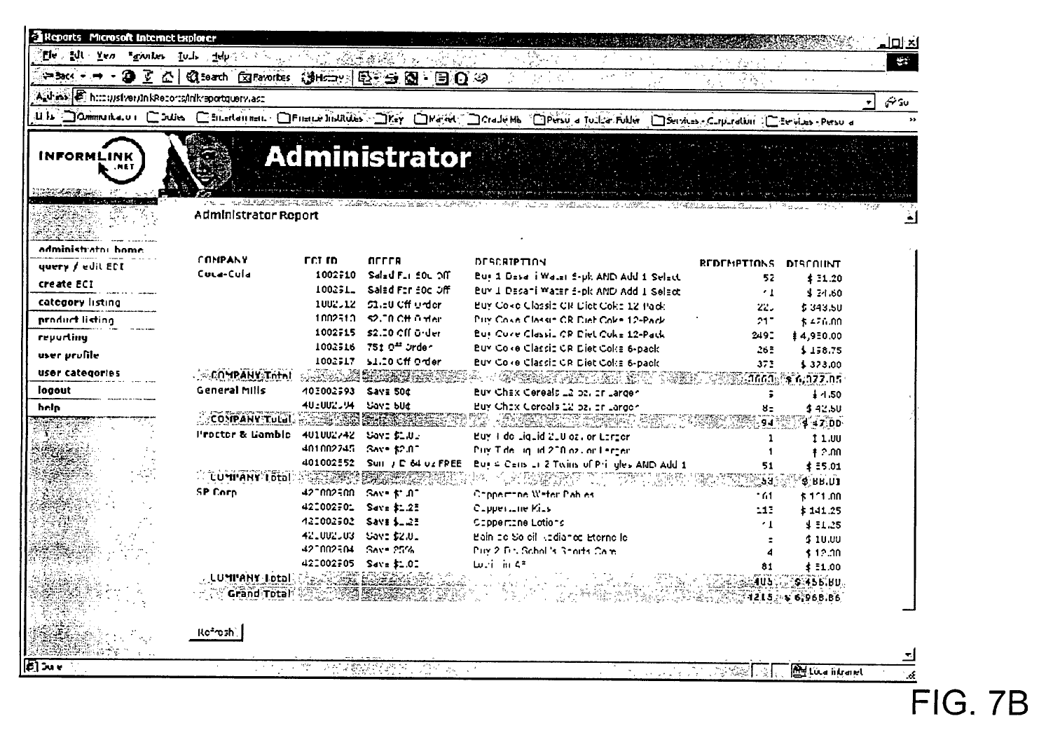

Reports are easily generated by promoters using the provided GUIs and selecting specific criteria. For example, users can specify report headings, select columns or fields for display (e.g. Retailer, Program number, Tracking Code, Title, InfomLink Cycle, Category Views, Trigger Views, Product Views, Redemption Count, Redeemed Value, Units Moved), data format (Formatted, HTML Raw or Excel), date range or other selected criteria. Illustrative report are included as FIGS. 7A and 7B.

In the present embodiment, the data collected from promoter servers and application servers are stored within data server 150. In this embodiment, data server typically includes an Oracle 8i database, although in other embodiments, other databases may be used for example, Sybase, Informix, or the like. In this embodiment, there are six logical groups of tables to store the collected data.

One logical group of tables stores data that may become “standardized” in the industry. Such tables hold data used by virtually any promoter, retailer, or the like, and include Category information, Product Information, and Market Information.

In this embodiment, Category information includes classifications of products or items into distinct groups, such as Dairy, Frozen Foods, Deli, and the like. More specifically, the present embodiment includes two tables. One table: Inlkcategory is defined as a fat-tree structure (non-cyclic DAG). Each node in the tree includes a category identifier (catid) and name pair. The table entries typically also include a parent category identifier (p_catid). Except for the root category, each category may have one or more parent categories. The exact structure of the category information will vary according to application.

Another table: InIkLeaf Category includes categories of products not having sub-categories. In this embodiment, only leaf category structures include actual products. Additionally, leaf categories and actual products are given a one to one mapping.

Product information is stored in two tables: InlkProduct and InlkBrand. In this embodiment, products with a data warehouse are uniquely defined by the InlkProduct table. Each product is defined by a universal product codes(UPC), a product name (e.g. Bounty), category identifier (catid), and a product description (e.g. paper towels) tuple in this table. Typically, the UPC is the primary key for this table. In other embodiments, other types of information may be included in these tables.

In this embodiment the InlkBrand table includes data including a brand identifier (Brdid), a brand name (e.g. Crayola), and set of products (e.g. 16 crayon box, markers, etc.) that belong to the brand (prodset). In one embodiment, the products may be identified by their respective UPC codes or in any other way.

Market information is stored in several tables including: InlkMarket, MarketZipCode, and Geographies. In this embodiment, such tables are used to divide the product market into multiple geographic markets. Typically zip codes are used for this, but in other embodiments, telephone area codes, states, counties, cities, congressional district, school district and the like may also be used as a basis to define market boundaries.

In this embodiment InlkMarket may store data such as a market identifier (mktid), typically a numerical assigned number. InlkMarket may also include a name of the market (e.g. Zip codes 94301-94305), and a description of the market (e.g. Northern Palo Alto). MarketZipCode table typically stores the correspondence between the mktid and zip code (zipcode). In this embodiment, the Geographics table stores the correspondence of the zipcode to physical geographic region. For example, 94025 would correspond to Southern Menlo Park.

Another logical group of tables stores data related to a promotion defined by a promoter. As will be illustrated below, the various types of promotion information entered by a promoter is stored in such tables. In this embodiment, the tables provided include promotions, promotion formulas, promotion target criteria, promotion delivery criteria, promotion appearance data, and the like.

In this embodiment a Promotion table includes promotion-related data. For example, the table may include a promotion universal product identifier (cpuc), one or more tracking codes, an effective date for the promotion, an expiration date of the promotion, a formula type, the type of targeting for the promotion, a promotion limit, a delivery type for the promotion, an appearance type, and a sponsor list. In other embodiments, a different types of information may be included or excluded from this table.

A promotion formula table is also provided in this example. The formula table is configured to include data such as an identifier (rule), a UPC for a product, a quantity for the product (quantity), a value type (e.g. percent, value, dollars), and a value. As an example, the formula table may include a tuple such as {1, 100, 2, P, 10}. Such a row in the table may specify that for a product having UPC=100, when a consumer buys quantity 2, by this formula, they are entitled to a 10% discount. Many other types of promotion formulas can be specified by such an arrangement.

A promotion target table is typically used to store information regarding criteria used to target the promotion. Entries in this table may include a target brand (bdi), target catid, a targeted retailer (Retid) (e.g. Kroger), a targeted market segment (mktid) (e.g. premium, economy), a targeted geographic region (geo), a target brand loyalty (brd and loy), a targeted volume (vol), and the like. Other types of targeting may be envisioned and included in additional embodiments in light of the present disclosure.

The present embodiment also includes a promotion delivery table and promotion appearance table. These tables specify how promotions are delivered to consumers as was described above. For example, a promotion may be delivered to a consumer based upon contents of the consumer's shopping carts or category of products the consumer is currently shopping. Further, in this example, the promotion may be delivered to the consumer in response to a search of promotions (SR-IB), to the consumer on a customized promotion page (PPP-IB), to the consumer on a personal shopping list (PSL-IB), to the consumer when the consumer is navigating in “aisles” in the store (AA-IB), to the consumer when the consumer is browsing on a “shelf” (AS-IB).

Another logical group of tables relates to promoters and retailers. In this embodiment, tables such as BrandManager and Retailer are provided to store contact information for brand managers/promoters and retailers, respectively. Additional tables are provided to store product branding information.

In this example, the BrandManager table may include table entries corresponding to a brand manager identifier (bmid), a brand manager name, contact address, brand manufacturer, and other similar information (Bmprofile). Similarly, the Retailer table may include entries corresponding to a retailer identifier (retid), an identifier that defines the market of the retailer (mktid), the retailer name and contact address, and a profile of the retailer (retprofile).

In the present embodiment, a BMCategory table is used to hold category information defined by the brand manager. This includes the brand manager identifier (bmid), a category identifier for the brand (catid) (e.g. premium wines), a parent category (p_catid) (e.g. all wines), and a name for the category (e.g. premium wines). Further, a BMProduct table is used to hold product information associated with the brand. This may include the brand manager identifier (bmid), the product upc code (pupc), an identifier of a category for the product (catid) (e.g. premium wines), a given name of the product (e.g. Robert Mondavi), and a description of the product (e.g. Special vintners reserve). In this embodiment, a BMMarket table holds market information given by the brand manager. Specifically, the BMMarket table includes the bmid, an identifier of the market for the brand (bmmktid), a market name (e.g. premium wines), a description for the market (e.g. wines over $50 per bottle), a market definition (mktdef), and the like.

Consumer-related data such as past purchasing history, demographic information, psychographics, and the like are typically stored in two consumer tables. In the present embodiment, each consumer is identified by a pair of (retailer-id, customer-id) identifiers. The consumer-related data stored is typically insufficient to specifically identify a consumer name, address, telephone number, or the like. Instead, consumer-related data typically identifies consumers by untraceable customer identification numbers. In alternative embodiments, an consumer “opt-in” policy may be provided and the consumer may voluntarily allow storage of personal identification data. By providing such personal identification data, the consumers may receive direct physical mailings of notices of promotions, may receive e-mail messages describing promotions, telephone calls, or the like.

In this embodiment, a MasterConsumer Table is provided to store consumer-related information. For example, data such as the retailer where the consumer shops (retid), a consumer identifier issued by the retailer (csid), a profile of the consumer (csprofile) (e.g. gender, age, zipcode), and a consumer shopping history, may be stored in this table. Additional shopping history is stored in a ShoppingPattern table. In this embodiment, the following data may be stored such as a retailer id (retid), the consumer identifier (csid), the brand shopped (brdid), and the shopping pattern (pattern) (e.g. every trip, every other trip). Additional data such as the quantity or value purchased, a shopping time period, and end date, and the like, may also be stored.

As a result of the promotion activity, a number of statistics regarding consumer redemption, promotion views, products, and the like are generated. These statistics are stored in a series of database tables. A first table titled InlkBDI relates to data related to brand development. In the present embodiment, the table includes an market identifier (mktid), a brand identifier (brdid), a brand development index (Bdi), and a time stamp. In this example, Bdi is calculated as follows: BDI (brand_name)=(volume of brand_name in ONE market/average volume of the brand_name in ALL markets)*100. In this embodiment, he volume of a brand_name means the sum of sales, measured in dollars or units, of all products included in the brand. E.g. brand name of Diet Coke have products of 04900001020, 04900000663, 04900000935, etc.

A second table titled IrilkCDI stores data related to category development. In the present embodiment, the table includes an market identifier (mktid), a category identifier (catid), a category development index (Cdi), and a time stamp. In this example, Cdi is calculated in a similar manner as Bdi, above but with regards to product category.

Redemption information is stored in a table titled InlkProductStat. The table stores data related to product sales and includes a Market identifier (Mktid), a product UPC (Pupc), a value describing the volume in sales (in dollars, quantity, or the like), a time stamp, a value representing a buying cycle (in weeks, months, or the like), and an average selling price. In other embodiments, additional data may also be stored including, maximum selling price, minimum selling price, products sold in addition to the product, geographic data, typical consumer profile, and the like. Still other types of data can be envisioned in light of the present invention.

Data related to promotion redemptions may be stored in a table titled MasterCouponLog. In the present embodiment, this table is used to store data including a retailer identifier (retid), a consumer identifier (csid), a promotion UPC (cupc), a description of how the promotion is used (e.g. mere consumer impression, promotion screened-out by promotion rules, redemption, and the like). In other embodiment, additional data may also be stored including, other promotions used in the same shopping trip, specially targeted one-time promotions used, and the like.

In other embodiments, other types of tables may be added, or tables may be combined above. It should be understood that re-grouping of data in tables are contemplated in view of the present patent application. Further details regarding database tables are described in the above referenced provisional applications.

In the foregoing specification, the invention has been described with reference to specific exemplary embodiments thereof. Many changes or modifications are readily envisioned. For example, the above has been illustrated with a series of illustrations of web pages. It should be understood that the web pages may be embodied as separate .html files, or as a single .html files. Accordingly, embodiments of the present invention may be displayed to a promoter as a single screen or as more than one screens. Such alternative embodiments are evident in light of the present patent disclosure.

Embodiments of the present invention may provide information to the user or consumer more than just promotional information. For example, embodiments may give suggestions such as recipes, related foods, suggested food courses; information in the form of text, video, audio, or the like; URLs of web pages for information; and the like.

Further, embodiments of the present invention may be applied to other areas than for purchase of goods, such as for rental or lease of real property, tangible property, or intangible property, for purchasing or contracting for services, for any financial or barter transaction, for any recommendations such as stock picks or sports betting, for non-profit or volunteer activities, for any application in which a user may benefit by the presentation of additional or related information, and the like.

Further embodiments may be implemented entirely within in-house brick and mortar store servers. Accordingly, the merchant servers, the central data server, and the application server may be owned or operated by one company or related companies. For example, a neighborhood grocer may provide one or more information terminals to shoppers. Based upon the shoppers shopping habits, demographics, or the like, the shopper may be informed that the grocer is offering them a promotion, e.g. buy three, get one free, or the like. Upon check out, if the shopper fulfills the pre-conditions of the promotion, the shopper is automatically given the benefit. Such embodiments can utilize the above described infrastructure to provide such service.

Further embodiments can be envisioned to one of ordinary skill in the art after reading the attached documents. In other embodiments, combinations or sub-combinations of the above disclosed invention can be advantageously made. The block diagrams of the architecture and flow charts are grouped for ease of understanding. However it should be understood that combinations of blocks, additions of new blocks, re-arrangement of blocks, and the like are contemplated in alternative embodiments of the present invention.

The specification and drawings are, accordingly, to be regarded in an illustrative rather than a restrictive sense. It will, however, be evident that various modifications and changes may be made thereunto without departing from the broader spirit and scope of the invention as set forth in the claims.

1. A central server for providing a promotion to a plurality of application servers comprises:
a processor; and
a tangible media coupled to the processor, the tangible media including:
code that directs the processor to receive from a user at a client system promotion setup data for the promotion;
code that directs the processor to receive a specification of an offer data for the promotion from the user;
code that directs the processor to receive a promotion targeting specification for the promotion from the user;
code that directs the processor to receive a specification of a method for delivering the promotion to the plurality of application servers;
code that directs the processor to form a specification for the promotion in response to the promotion identifier, the offer type, the promotion targeting specification, and the method for delivering the promotion;
code that directs the processor to store the specification in a memory; and
code that directs the processor to transmit the promotion to the plurality of application servers.

2. The computer program product of claim 1 wherein the promotion setup data is selected from the class: tracking number, program number, promotion cycle, promotion phenotype, retailer identifier.

3. The computer program product of claim 2 wherein the offer data comprises an offer type selected from the class: cents off, percentage discount, price point, buy x get y for z, buy x get y free, free sample.

4. The computer program product of claim 3 wherein the offer data comprises a redemption limit selected from the class: maximum dollars redeemed in a promotional campaign, maximum number of redemptions redeemed in the promotional campaign, maximum number of redemptions redeemed per shopping trip.

5. The computer program product of claim 1 wherein the promotion targeting specification comprises a targeting criteria for consumers selected from the class: consumer consumption in a product category, consumer consumption of a identifiable product, consumer product purchasing loyalty, consumer geographic region.

6. The computer program product of claim 1 wherein the specification of the method for delivering the promotion comprises a triggering criteria selected from the class: products within a consumer shopping cart, category of products being shopped by the consumer.

7. The computer program product of claim 1 wherein the tangible media also includes code that directs the processor to transmit the promotion identifier, the offer type, the promotion targeting specification, and the method for delivering the promotion to the client system.

8. A client system for defining a promotion for distribution to a plurality of servers comprises:
a display; and
means for receiving a plurality of web pages to be displayed on the display, the plurality of web pages specified by a central server;
means for displaying a plurality of web pages on the display;
means for receiving setup data for the promotion from the user in response to a first prompt on the plurality of web pages on the display;
means for receiving a specification of an offer for the promotion from the user in response to a second prompt on the plurality of web pages on the display; and
means for transmitting the setup data and the specification of the offer to the central server using TCP/IP;
wherein the central server transmits a specification for the promotion to the plurality of servers, the specification including the setup data and the specification of the offer.

9. The client system of claim 8 further comprising:
means for receiving a targeting specification for the promotion from the user in response to a third prompt on the plurality of web pages on the display; and
means for receiving a specification of a method for delivering the promotion to customers in response to a fourth prompt on the plurality of web pages on the display;
wherein the means for transmitting also includes means for transmitting the targeting specification and the method for delivering the promotion to the plurality of servers to the central server.

10. The client system of claim 9
wherein the plurality of web pages comprises a first page and a second page, the first page including the first prompt and the second page including the third prompt.

11. The client system of claim 8 wherein the offer comprises a description of a pre-condition action required by a customer and a description of a benefit provided to the customer upon satisfaction of the pre-condition.

12. The client system of claim 9 wherein the plurality of servers is selected from a superset of servers.

13. The client system of claim 9 wherein the targeting specification specifies consumers who are offered the promotion based upon data selected from the group: usage of targeted products, brand loyalty, geographic location, consumption of products within a target category.

14. The client system of claim 9 wherein the method for delivering the promotion to the customers is in response to data selected from the group: products within a customers' shopping cart, product category being shopped by the customer.

15. A computer program product for a central server including a processor for distributing promotions to a plurality of servers comprises:
a tangible memory comprising:
code that directs the processor to provide a plurality of web pages for display to a client system;
code that directs the processor to receive promotion setup data from the client system, the promotion setup data provided by a promoter in response to a first prompt on the plurality of web pages;
code that directs the processor to receive an offer specification from the client system, the offer specification provided by the promoter in response to a second prompt on the plurality of web pages;
code that directs the processor to receive a targeting specification for the promotion from the client system, the targeting specification provided by the promoter in response to a third prompt on the plurality of web pages;
code that directs the processor to form a promotion specification in response to the promotion setup data, the offer specification, and the targeting specification;
code that directs the processor to store the promotion specification in a database; and
code that directs the processor to distribute at least a portion of the promotion specification to only the plurality of servers from a superset of servers in response to the promotion specification.

16. The computer program product of claim 15 wherein the tangible media also includes:
code that directs the processor to receive a delivery specification for the promotion from the client system, the delivery specification provided by the promoter in response to a fourth prompt on the plurality of web pages;
wherein the code that directs the processor to form the promotion specification comprises code that directs the processor to form a promotion specification in response to the promotion setup data, the offer specification, the targeting specification, and the delivery specification.

17. The computer program product of claim 15 wherein the offer specification comprises a pre-condition and benefit pair and selected from the class: purchase and receive a percentage discount, purchase and receive a monetary discount, purchase X quantity and receive Y quantity for an amount selected from the class: specified monetary amount, free.

18. The computer program product of claim 15 wherein the targeting specification specifies a selection from the group: target shopping category, target consumer usage, target consumer loyalty, target geographic consumer, target consumer demographic.

19. The computer program product of claim 16 wherein the delivery specification specifies the promotion is presented to a consumer based upon data selected from: products within the customer's shopping cart, product category visited by the customer.

20. The computer program product of claim 15 further comprising:
code that directs the processor to receive a promotion appearance from the client system, a promotion appearance specifying an appearance of the promotion to a consumer.
